(19) United States
(12) Patent Application Publication
(10) Pub. No.: US 2015/0276651 A1
(43) Pub. Date: Oct. 1, 2015

(54) ANALYTE SENSOR AND FABRICATION METHODS

(71) Applicant: EDWARDS LIFESCIENCES CORPORATION, Irvine, CA (US)

(72) Inventors: James R. Petisce, Westford, MA (US); Alexander H. Gorham, Costa Mesa, CA (US); David Zhou, Santa Clarita, CA (US)

(73) Assignee: Edwards Lifesciences Corporation, Irvine, CA (US)

(21) Appl. No.: 14/436,211

(22) PCT Filed: Oct. 7, 2013
(86) PCT No.: PCT/US13/63729

§ 371 Date: Apr. 16, 2015

Related U.S. Application Data
(60) Provisional application No. 61/720,262, filed on Oct. 30, 2012.

(51) Int. Cl. G01N 27/327; C23F 1/26; C23F 1/12; C23F 1/44

(52) U.S. Cl. CPC G01N 27/3271; C23F 1/44; C23F 1/26; C23F 1/12

(57) ABSTRACT

Methods for fabricating analyte sensor components using IC- or MEMs-based fabrication techniques and sensors prepared therefrom. Fabrication of the analyte sensor component comprises providing an inorganic substrate having deposited thereon a release layer, a first flexible dielectric layer and a second flexible dielectric layer insulating there between electrodes, contact pads and traces connecting the electrodes and the contact pads of a plurality of sensors. Openings are provided in one of the dielectric layers over one or more of the electrodes to receive an analyte sensing membrane for the detection of an analyte of interest and for electrical connection with external electronics. The plurality of fabricated sensor components are lifted off the inorganic substrate. Methods of improving sensor performance by solution based and non-solution based etching are provided.

### BACKGROUND

### 1. Technical Field

This disclosure relates generally to analyte measuring systems and methods, and more particularly to methods for manufacturing of analyte sensors using microfabrication and lift-off techniques. Methods of improving sensor performance of such sensors by chemical and ion etching are provided.

Controlling blood glucose levels for diabetics and other patients can be a vital component in critical care, particularly in an intensive care unit (ICU), operating room (OR), or emergency room (ER) setting where time and accuracy are essential. Presently, one of the most reliable ways to obtain a highly accurate blood glucose measurement from a patient is by a direct time-point method, which is an invasive method that involves drawing a blood sample and sending it off for laboratory analysis. This time-consuming method is often incapable of producing needed results in a timely manner. Other minimally invasive methods such as finger-stick methods involve the use of a lancet or pin to pierce the skin to obtain a small sample of blood, which is then applied to a test strip and analyzed by a glucose meter. While these minimally invasive methods may be effective in determining trends in blood glucose concentration, they generally do not track glucose accurately enough to be used for intensive insulin therapy, for example, where inaccuracy at conditions of hypoglycemia could pose a very high risk to the patient.

Electrochemical analyte sensors have been developed for measuring various analytes in a substance, such as glucose. An analyte is a substance or chemical constituent that is determined in an analytical procedure, such as a titration. For instance, in an immunoassay, the analyte may be the ligand or the binder, where in blood glucose testing, the analyte is glucose. Electro-chemical analyte sensors comprise electrolytic cells including electrodes used to measure an analyte. Two types of electrochemical analyte sensors are potentiometric and amperometric analyte sensors.

Amperometric analyte sensors, for example, are known in the medical industry for analyzing blood chemistry. These types of sensors contain enzyme electrodes, which typically include an oxidase enzyme, such as glucose oxidase, that is immobilized behind a membrane on the surface of an electrode. In the presence of blood, the membrane selectively passes an analyte of interest, e.g. glucose, to the oxidase enzyme where it undergoes oxidation or reduction, e.g., the reduction of oxygen to hydrogen peroxide. Amperometric analyte sensors function by producing an electric current when a potential sufficient to sustain the reaction is applied between two electrodes in the presence of the reactants. For example, in the reaction of glucose and glucose oxidase, the hydrogen peroxide reaction product may be subsequently oxidized by electron transfer to an electrode. The resulting flow of electrical current in the electrode is indicative of the concentration of the analyte of interest.

Manufacture of analyte sensor can be problematic. To achieve accurate analyte measurement, close tolerances must be achieved during manufacture. For example, slight differences in the dimensions of the first and second working electrodes can create an electrical offset between the outputs of the two electrodes. This offset may result in a less accurate analyte concentration measurement. Many analyte manufacturing techniques require a large number of steps, where each step may introduce error and/or tolerance variations. This, in turn, results in difficulty in manufacturing of large numbers of analyte sensors with high reliability and repeatability.

### SUMMARY

Aspects disclosed and described herein provide for the manufacture of miniaturized biosensors components and methods for measuring an analyte concentration using an analyte sensor, which can be further miniaturized. The systems and method include an analyte sensor manufactured using microelectromechanical (MEMs) and/or integrated circuit (IC) fabrication processes. The resultant analyte sensor is capable of sensing the analyte concentration and outputting a signal corresponding to the analyte concentration. With the disclosed aspects, the number of production steps of the assembly of functional in vivo sensors can be reduced. Accordingly, mass produced, high density, cost reduced, high reliability sensors will be achieved.

MEMs and/or IC fabrication technology provides for the manufacture of amperometric sensor components suitable for analyte detection, and in particular, glucose detection. MEMs and/or IC fabrication technology makes possible analyte sensor components of sub-micron to micron size that can be integrated with other electronics. Furthermore, MEMs and/or IC fabrication technology provides for batch fabrication of analyte sensors in large quantities, thus reducing costs while potentially improving quality. MEMs/IC sensors are fabricated through batch production process employing lithography, which provides 3-dimensional structures using pre-designed resist patterns (masks). Applicants have determined that amperometric analyte sensor manufacturing may be advantageously integrated into MEMs/IC fabrication technology to provide accurate, high quality sensors for detection of analytes of interest.

According to one aspect disclosed and described herein, methods are provided for MEMs and/or IC fabrication of an analyte sensor component. An analyte sensor component is fabricated on a semiconductor substrate and comprises at least one of continuously connected isolated reference, working, and blank electrode.

In a first embodiment, a method of fabricating an electrochemical sensor component is provided. The method comprises providing a substrate having a transition metal adhesion layer positioned between a dielectric layer and a noble metal electrode, the noble metal electrode having residual amounts of the transition metal adhesion layer on the surface thereof, contacting the exposed portion of the noble metal electrode with an etchant, and removing at least a portion of the residual transition metal adhesion layer from the surface of the noble metal electrode. In various aspects, the substrate has at least one opening formed there through (e.g., a via) and the portion of the noble metal electrode surface having the residual transition metal adhesion layer is exposed to etchant.

In a first aspect of the first embodiment, the transition metal adhesion layer comprises titanium.

In second aspect, alone or in combination with the previous aspect of the first embodiment, the noble metal comprises gold, platinum, platinum/iridium, or palladium. In a particular embodiment, the transition metal adhesion layer comprises titanium and wherein the noble metal comprises gold, platinum, or palladium.

In third aspect, alone or in combination with any of the previous aspects of the first embodiment, the etchant is a solution based etchant.

In fourth aspect, alone or in combination with any of the previous aspects of the first embodiment, the etchant comprises hydrogen fluoride.

In fifth aspect, alone or in combination with any of the previous aspects of the first embodiment, the etchant is a non-solution based etchant. In certain aspects, the non-solution based etchant comprises ions. In at least one aspect, the ions are provided by inductively coupled plasma or ion beam.

In a second embodiment, a method of improving the electrochemical response of a microfabricated electrochemical sensor component to an electrochemically active species is provided. The method comprises the steps of: (i) providing a substrate having a transition metal adhesion layer positioned between a dielectric layer and a noble metal electrode, the noble metal electrode having residual amounts of the transition metal adhesion layer on the surface thereof; (ii) contacting the exposed portion of the noble metal electrode with an etchant; and (iii) removing at least a portion of the residual transition metal adhesion layer from the surface of the noble metal electrode, where the electrochemical response of the noble metal electrode to an electrochemically active species is greater than without the contacting step.

In a first aspect of the first embodiment, the transition metal adhesion layer comprises titanium.

In second aspect, alone or in combination with the previous aspect of the second embodiment, the noble metal comprises gold, platinum, platinum/iridium, or palladium. In a particular embodiment, the transition metal adhesion layer comprises titanium and wherein the noble metal comprises gold, platinum, or palladium.

In third aspect, alone or in combination with any of the previous aspects of the second embodiment, the etchant comprises solution-based etching.

In fourth aspect, alone or in combination with any of the previous aspects of the second embodiment, the etchant comprises hydrogen fluoride.

In fifth aspect, alone or in combination with any of the previous aspects of the second embodiment, the etchant comprises non-solution based etching. In certain aspects, the non-solution based method comprises ions. In at least one aspect the ions are provided by inductively coupled plasma or ion beam.

An electrochemical analyte sensor made by the methods described herein is also provided.

### BRIEF DESCRIPTION OF THE DRAWINGS

Henceforth reference is made the accompanied drawings and its related text, wherein:

FIG. 1 is a schematic diagram of a four-electrode electrochemical sensor component used in some aspects disclosed and described herein;

FIG. 2 is a schematic diagram of a top plan view of an electrochemical sensor component used in some aspects disclosed and described herein;

FIG. 3 is a schematic diagram of a cross-sectional view of a sensor used in some aspects disclosed and described herein;

FIG. 4 is a flow chart of a method of fabricating an electrochemical sensor component used in a first embodiment disclosed and described herein;

FIG. 5-10 are schematic diagrams of a cross-sectional views illustrating the first embodiment of a fabrication process of an electrochemical sensor component;

FIG. 11 is a flow chart of a method of fabricating an electrochemical sensor component used in a second embodiment disclosed and described herein;

FIGS. 12-20 are schematic diagrams of a cross-sectional views illustrating the second embodiment of a fabrication process of an electrochemical sensor component;

FIG. 21 is a flow chart of a method of fabricating an electrochemical sensor component used in a third embodiment disclosed and described herein;

FIGS. 22-28 are schematic diagrams of a cross-sectional views illustrating the third as embodiment of a fabrication process of an electrochemical sensor component;

FIG. 29 is a schematic diagram of an exploded cross-sectional views illustrating an analyte sensing membrane;

FIGS. 30-32 are schematic diagrams of a top plan views of sensor electrode, trace and contact pad fabrication used in some aspects disclosed and described herein;

FIG. 33 is a schematic diagram of a cross-sectional view illustrating the sensor of FIG. 32;

FIGS. 34-36 are schematic diagrams of a top plan views of sensor electrode, trace and contact pad configurations used in some aspects disclosed and described herein;

FIG. 37 is a schematic diagram of an analyte sensing membrane, whereby the individual layers of the analyte sensing membrane are draped over the opening exposing the working electrode, as used in some aspects disclosed and described herein;

FIG. 38 is a chart of the current response to glucose of an experimental sensor used in an aspect disclosed and described herein after exposure to concentrations of glucose; and

FIG. 39 is a chart of the current response to glucose of an experimental sensor used in an aspect disclosed and described herein after exposure to concentrations of glucose.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Disclosed are methods for fabricating analyte sensors, such as a glucose sensor, using IC- or MEMs-based fabrication techniques. Fabrication of the analyte sensor comprises providing an inorganic substrate, isolating, between a first flexible dielectric layer and a second flexible dielectric layer, a plurality of individual continuously connected electrodes, traces and contact pads comprised of a conductive material, where the first flexible dielectric layer is deposited on the inorganic substrate, and forming openings in the second flexible dielectric layer exposing at least a portion of one of the individual continuously connected electrodes and contact pads. Openings are provided to receive an analyte sensing membrane for the detection of an analyte of interest and optionally, for electrical connection with the contact pads. In one aspect, the fabricated sensor component may be lifted off the semiconductor substrate and incorporated into a flex circuit or medical device.

To provide acceptable adhesion of certain conductive materials with the overlaying (and underlying) dielectric material, it may be necessary to use transition metal adhesion layers at the interfaces of the dielectric and the conductive material. During processing of the microfabricated device, the deposition, e.g., sputtering, of a thin layer of adhesion material followed by the conductive material forming the electrode can be carried out in a sequential manner to avoid breaking vacuum, contaminating, and/or forming native oxides. In certain constructs of the microfabricated sensor disclosed and described herein, a noble metal serving as the electrode is coated with a transition metal to provide adhesion to an overlayer of dielectric material, for example, a polymeric dielectric material that is subsequently patterned and developed to expose a portion of the conductive electrode. Removal of the overlayer of dielectric may result in trace amounts of residual transition metal adhesion layer on the electrode. Because of the formation of native oxides, such residual adhesion material can reduce the electrochemical efficiency of the electrode.

It is generally know that the removal of titanium from microfabricated parts is somewhat difficult due to the native titanium (di)oxide present. This is even more compounded for biosensors which can be fabricated on flexible, polymeric substrates that are not suitable for many etching methods due to their high organic content and/or very thin metal substrate layers. It has been now found that certain solution based etchants and non-solution based etchants can be used to selectively etch the titanium transition metal along with the native oxides with little or no etching of the noble metal and minimal etching of the dielectric. As used herein, the term “etchant” is inclusive of solution based etchants and non-solution based etchants. Solution based etchants include, for example, aqueous hydrogen fluoride. Non-solution based etchants include, for example, inductively coupled plasma etching (ICP), ion beam etching (inclusive of chemically assisted and thermally assisted ICP) and reactive ion etching (RIE).

Thus, in one embodiment, a solution based etching method can be used to remove a transition metal adhesion layer sandwiched between a noble metal and a dielectric, the noble metal exposed by an opening in an over-coated dielectric layer. As used herein, “solution based etching” and “solution based etchant” are intended to be inclusive of chemical etchants and chemical etching methods carried out in solution. The solution can be aqueous, non-aqueous, non-aqueous electrolyte, or a mixture. In one aspect, hydrogen fluoride (HF) is used a chemical etchant.

In another embodiment, a non-solution based etching method can be employed. As used herein, “non-solution based etching” and “non-solution based etchant” are intended to be inclusive of inductively coupled plasma etching (ICP), ion beam etching (inclusive of chemically assisted and thermally assisted ICP) and reactive ion etching (RIE). Such etching methods are generally anisotropic, in that they tend to avoid lateral etching. As such, it may be preferred to employ such methods. In one aspect, ion beam etching (IBE) can be employed using generally known techniques.

It has been found that a microfabricated sensor construct or component thereof comprising a noble metal/transition metal/dielectric layer configuration having previously defined openings created over the noble metal can be exposed to an etchant that selectively removes the transition metal adhesion layer sufficiently to increase the output signal of the microfabricated device compared to a similarly constructed device that has not be etched as herein disclosed. Thus, improved microfabricated devices are provided with little impact on the processing of the device.

Generally, ion beam etching (IBE) was preferred over hydrofluoric acid (HF) etching for at least the following reasons: it is safer, more controllable, and reduces contamination/waste. With IBE, the exposure rate and time can be specified, and the process can easily be applied to an entire wafer. Etching with hydrofluoric acid is at least dependent on agitation rate which can be hard to precisely control. Hydrofluoric acid is surrounded by safety and regulatory issues. It also introduces contamination opportunities as the etched titanium remains in the HF bath and can possibly redeposit on the sensor. Nonetheless, HF remains a viable option to improve the signal output of microfabricated sensors and can be employed in the various methods disclosed and described herein.

The inorganic substrate may be a semiconductor. Suitable semiconductor substrates may be of conventional semiconductor materials such as silicon, silicon dioxide, or gallium arsenide. Silicon substrates may have native oxide or polysilicon layer or may have silicon nitride layers. Other inorganic, semi-conductive or non-conductive materials may be used as a substrate. In one aspect, the inorganic substrate excludes borosilicate glasses as these materials are generally not readily adaptable to MEMs/IC processing.

In one aspect, fabrication of the analyte sensor comprises depositing a release layer on the substrate to provide for subsequent release of the fabricated sensor component. In this aspect, a plurality of fabricated sensor components may be “lifted off” the substrate, providing for sensors with sufficient flexibility for incorporation into or on flex circuits, medical devices, e.g., catheters, and the like.

In a preferred aspect, the release layer preferably has one or more of the following attributes: a solubility in a solvent that does not dissolve subsequently formed flexible dielectric layers; etches (wet or dry) at a rate faster than that of the first flexible dielectric layers of the sensor; or is a pressure sensitive adhesive material interposed between substantially all of the first dielectric material and the inorganic substrate.

Preferably, the release layer is of a composition having a solubility or an etching profile different from the dielectric material and/or substrate so as to facilitate separation of the sensor component from the substrate. In one aspect, the release layer is a photosensitive material that changes its solubility upon exposure to actinic radiation. Thus, for example, the release layer may be initially insoluble in aqueous media or aqueous base (cast from an organic solvent), but upon exposure to actinic radiation, the release layer becomes readily soluble in aqueous media/base. After depositing the release layer cast with an organic solvent, the layer is flood exposed to render the release layer insoluble in organic solvent and soluble in aqueous media. By using dielectric materials that are insoluble in aqueous media provides for dissolution of the release layer and separation of dielectric layer of the fabricated sensor component from the substrate. Examples of materials suitable as release layers would include, for example, positive novalak/diazonaphthaquinone resists and/or chemically amplified photoresists (partially blocked vinylphenol chemically amplified resists, polybutene 1-sulfone and the like) generally know in the MEMs/IC manufacture art.

In another aspect, an inorganic thin-film may be used as the release layer. For example, a thin film of silicon oxide or silica glass may be used as the release layer for an inorganic substrate (e.g., silicon wafer). In this aspect, the fabricated sensor component may be released by HF (hydrofluoric acid) wet etching. Since HF will attack exposed metal electrodes and pads, a photoresist protection layer may be used to protect the sensor surface during HF wet etching. The thin-film inorganic release layer may of a thickness of about 10 nm to about 500 nm. Other thickness may be used. The film may be deposited by sputtering, for example.

In another aspect, a metal sacrificial layer may be used to release the electrochemical sensor component from a substrate. For example, titanium or chrome (100-500 nm) may be deposited by sputtering or evaporative techniques on a substrate such as silicon wafer. Then, a thin layer of aluminum (300-1000 nm) may be deposited on the Ti or Cr layer. After partial or complete fabrication of polymer sensor the aluminum layer may be etched away to release the sensors from substrate. The thin aluminum layer may be etched chemically or electrochemically. For example, the substrate may be electrochemically etched by immersion in a strong electrolyte solution, such as 1-2 M potassium chloride or sodium chloride at room temperature. The anodic metal dissolution is carried out by applying an anodic DC voltage of 0.5-1.0 V on the aluminum layer vs. a larger Pt or carbon counter electrode. After aluminum is dissolved, more stable and inert chrome or titanium layer remains on the substrate, thus releasing the polymer sensors. The metal release layer may of a thickness of about 10 nm to about 500 nm. Other thickness may be used. The film may be deposited by sputtering, for example.

In another aspect, the release layer is a pressure sensitive adhesive (PSA) or the like, disposed between the first flexible dielectric layer and the substrate such that the sensors may be mechanically removed from the substrate. Preferably, the pressure sensitive adhesive is disposed essentially completely between the first flexible dielectric layer and the substrate. The PSA may be deposited by casting, dipping, or spin coating, for example.

The fabrication of the analyte sensor comprises depositing dielectric material on conductive material formed on the substrate and defining perimeters therein to isolate continuously connected electrodes, traces and contacts. For example, the dielectric material may be patterned to provide for subsequent formation of one or more isolated, continuously connected electrodes, traces and contact pads. Additional dielectric layers are used for defining openings over at least one of the electrodes and contact pads. Patterning of the dielectric material may be performed using known photoresist/mask techniques. For example, a polyimide or polyepoxide photoresist material may be used as the dielectric. In one aspect, the dielectric material comprises multiple polymeric layers of suitable material characteristics and properties. Thus, the fabrication process may comprise deposition of a first polymer layer formed of a suitable dielectric material such as polyimide, parylene, polydimethylsiloxane, or polyepoxide, at a thickness suitable for electrical isolation of the sensor components and/or for providing sufficient flexibility and durability during fabrication and intended use. The dielectric polymer layers may be deposited at thicknesses of about 15 μm, 10 μm, 5 μm, 1 μm or less. Other thicknesses of dielectric polymer layer may be used. The dielectric polymer layer may be deposited using known methods such as spin coating, casting and the like. Preferably, the dielectric polymer is photosensitive such that it may be imaged using photolithographic techniques. Thus, in one aspect, one or more of the dielectric polymer layers are photosensitive (positive or negative photoresists). For example, a photosensitive polyimide or photosensitive polyepoxide may be used and the perimeters formed therein using photolithographic methods and etching/developing, or alternatively, by laser ablation. Processes of forming the perimeters in the dielectric may include image reversal using a positive photoresist.

Thus, in one embodiment, a fabrication process comprises coating a first flexible dielectric layer on a semiconductor substrate having disposed thereon a release layer as described above. A conductive material is then deposited over the first flexible dielectric polymer layer (optionally over a previously applied adhesion layer). A photosensitive mask layer with suitable etching properties is then deposited over the conductive material and patterned to define the perimeters of the individual electrodes, traces and contact pads. Etching of the photosensitive mask layer and conductive material provides a plurality of isolated continuously connected electrodes, traces and contact pads. Alternatively, the conductive layer may be laser ablated to define the features. A second flexible dielectric is applied to the surface of the conductive material (optionally over an adhesive layer). Photolithography or laser ablation may be used to create the openings over the electrodes and to expose the contact pads. An analyte sensing membrane may be deposited into one or more openings over the electrodes to provide a plurality of electrochemical sensor components on the substrate. The dielectric layers, electrodes and the defined openings forming the electrochemical sensor components may be lifted off the substrate for deposition of an analyte sensing membrane and/or coupling with a flex circuit or medical device. The individual sensors may be separated from each other using laser cutting, RIE etching, or dicing methods, for example.

The flexibility of the fabricated sensor component can be controlled by the thickness of the first flexible dielectric polymer layer. The flexibility may be adjusted for a particular application, such as, for example, for introduction into a catheter, for example, to accommodate tortuous path introduction into a subject.

In another embodiment, a fabrication process comprises coating a first flexible dielectric polymer layer on a semiconductor substrate having deposited thereon a release layer. A photosensitive mask layer is then coated over the first dielectric polymer layer. The mask layer may be lithographically patterned to provide one or more isolated openings and/or trenches for receiving conductive material. For example, a positive or negative photoresist material may be used and exposed/developed to provide one or more openings and/or trenches in the mask layer. A conductive material is then deposited over the mask layer (optionally over a previously applied adhesion layer) and into the openings/trenches defining the plurality of individual continuously connected electrodes, traces and contact pads. Removal of any excess conductive material on the surface of the mask may be accomplished by etching or chemical polishing techniques. The mask layer is then removed by solvent or etching to provide isolated features defining the electrodes traces and contact pads. Then a second, preferably, photosensitive dielectric layer is applied over the isolated conductive material and openings are defined therein over one or more of the electrodes/contact pads using photolithographic methods or laser ablation. An analyte sensing membrane may be deposited into one or more openings over the electrodes and/or draping or encapsulating the membrane to provide a plurality of electrochemical sensors on the substrate. The dielectric layers and the defined openings forming the electrochemical sensors may be lifted off the substrate. The individual sensors may be separated from each other using laser cutting or dicing methods, for example.

In yet another embodiment, a fabrication process comprises depositing a first flexible dielectric material directly on a semiconductor substrate and then coating the dielectric with a conductive material (optionally over a previously applied adhesion layer) followed by coating with a photosensitive mask layer. Photolithography or laser ablation may be used to create the perimeters of the continuously connected conductive electrode, contact pads and traces in the photosensitive mask layer as described above. The plurality of individual electrodes, traces, and contact pads are then formed by developing and/or etching of the mask and excess conductive material. A second flexible dielectric layer is then applied and openings are formed over one or more of the isolated continuously connected electrodes and contact pads using photolithographic methods or laser ablation. In this aspect, the fabricated sensor has a set rigidity based on the thickness of the semiconductor substrate. The rigidity may be adjusted for a particular application, such as by etching or polishing the semiconductor substrate until a desired thickness is obtained. Alternatively, the fabrication process may comprise coating a first flexible dielectric material on the substrate and a second photosensitive dielectric material on the first flexible dielectric material (optionally over a previously applied adhesion layer). The second polymer layer may be patterned to provide one or more isolated openings, trenches and/or vias for receiving the conductive material, as described above.

The openings, trenches and/or vias of the sensor may be fabricated with an aspect ratio (height to width) of between about 1:100 to about 100:1. Preferably, the aspect ratio is between 1:10 and 10:1 and more preferably, the aspect ratio is between 1:5 and 5:1. In one aspect, the aspect ratio is high (e.g., 2:1 or greater) such that the analyte sensing membrane is contained or otherwise positioned within the opening and includes being flush with the surface of the dielectric material defining the opening. In other aspects, the aspect ratio is low (e.g., 1:2 or greater) such that the analyte sensing membrane drapes over the opening and includes filling the opening with the analyte sensing membrane.

Other MEMs/IC fabrication techniques may be used to provide a semiconductor substrate having a dielectric material insulating traces connecting electrodes and contact pads and for defining openings over one or more of the electrodes to receive a sensing membrane and for defining openings over one or more of the contact pads for electrical connection therewith.

Fabrication of the electrodes, traces and contact pads may comprise successive deposition of thin films of material, including, for example, releasing and/or adhesion layers, dielectric material, conductive material, and photosensitive material. Deposition of the release layer and dielectric material may be by casting or spin coating. Deposition of the adhesion layer and conductive material onto the substrate or dielectric material is accomplished by convention methods (e.g., chemical vapor deposition, epitaxy, electrodeposition, or thermal oxidation) or by physical reaction-based approaches (evaporation, sputtering, casting, e-beam, electroless plating, or electroplating). Electrode, trace, and contact pad conductive material is formed over the first polymer layer and optional metal adhesion layer by sputtering, chemical vapor deposition (CVD), or electro- or electroless-plating methods. The electrode, trace, and contact pad conductive material may be deposited with a thickness of about 500 nm or more. The electrode, trace, and contact pad conductive material may be patterned using known techniques to provide the desired sensor architecture.

The electrodes, traces, and contact pads may be made of different conductive materials. Electrode, trace, and contact pad conductive material may be deposited by sputtering, chemical vapor deposition (CVD), or electro- or electroless-plating methods. The conductive material may be deposited with a thickness of about 500 nm or more. The conductive material may be patterned using known techniques to provide the desired sensor architecture, including, for example, electrodes, traces, and contact pads. In one aspect, the working electrode may be a platinum based enzyme electrode, i.e. an electrode having disposed thereon an analyte sensing membrane. The same or different conductive materials may be used for any of the electrode, trace, and contact pad structures. For example, the contact pads may be formed of a material such as gold (Au) platinum (Pt), palladium (Pd), ruthenium (Ru), rhodium (Rh), iridium (Ir), carbon (C), or other material that resists oxidation. The traces may be formed of any suitable conductive material, such as gold (Au), platinum (Pt), nickel (Ni), or copper (Cu). The electrode material may of any suitable material, and for example, may be formed of platinum (Pt), gold (Au), palladium (Pd), ruthenium (Ru), rhodium (Rh), iridium (Ir), silver (Ag), carbon (C) and their alloys or oxides. Conducting polymers, such as polypyrrole (PPy), polyaniline (PANi), polythiophene, poly(3,4-ethylenedioxythiophene) (PEDOT) or their derivatives can also be used to form the electrodes, traces, or contact pads.

A reference electrode may be used to input a bias signal into the amperometric sensor. In some embodiments, the reference electrode is formed by depositing silver (Ag) in one of the fabricated openings and then converting the silver to silver chloride (Ag/AgCl), either chemically or electrochemically. Masking techniques generally known in IC manufacturing may be used to selectively deposit different metals/materials to form the various electrodes (e.g., working, counter and reference electrodes).

Optionally, an adhesion layer may be provided over the dielectric material and/or conductive material to facilitate the bonding and/or improve adhesion to an adjacent layer. Typically, adhesion layers are used to improve adhesion between metals and polymers. Adhesion layers may be formed by sputtering or plating methods, for example. For metal/polymer interfaces, the adhesion layer is preferably metallic. The metallic adhesion layers can be of any suitable material, such as titanium (Ti), nickel (Ni), tungsten (W), chromium (Cr), or combination of these metals or alloys for example, and may be deposited by sputtering, chemical vapor deposition (CVD), or electro- or electroless-plating methods. In one aspect, the metallic adhesion layer may be of titanium (Ti) with thickness in the area of 10-100 nm, however, other thicknesses may be used. The adhesion layer may be patterned to provide for selective deposition of the conductive material.

Fabrication of the various components of the sensor, such as the arrangement of the electrodes, traces and contact pads, as well as the deposition of the conductive material are advantageously carried out using MEMs/IC processes. Various shaped sensors with various dimensions ranging from micrometers to millimeters can be batch manufactured. Sensor electrodes made of a pure metal such as platinum (Pt) may have higher sensitivity than alloys and/or conductive inks, thereby providing for higher signal to noise ratios. One advantage of IC/MEMs fabrication technology as opposed to conventional silk screening or other electrode deposition methods of fabricating sensors may be greater reproducibility from electrode to electrode, sensor to sensor, and panel of sensors to panel of sensors. Reproducibility of electrodes is important at least in terms of manufacture of working and blank electrodes, as accurate structural matching of these two electrodes in a sensor reduces electrical output offset between the electrodes.

Various shaped sensors with various dimensions ranging from micrometers to millimeters can be batch manufactured. Sensor electrodes made of a pure metal such as platinum (Pt) may have higher sensitivity than alloys and/or conductive inks, thereby providing for higher signal to noise ratios, and therefore may be preferred. One advantage of IC/MEMs fabrication technology as opposed to conventional silk screening or other electrode deposition methods of fabricating sensors may be greater reproducibility from electrode to electrode and panel of sensors to panel of sensors. Reproducibility of electrodes is important at least in terms of manufacture of working and blank electrodes, as accurate structural matching of these two electrodes in a sensor reduces electrical output offset between the electrodes.

Different structural embodiments of the sensor structure and spatial arrangement of electrode, trace and contact pad may be used. For example, electrodes of different shapes and different dimensions may be employed. Two smaller counter electrodes may be used, as opposed to a larger single counter electrode, while maintaining a larger surface area ratio between the counter electrode and working electrode. The working electrode(s) may be positioned between a counter electrode and a reference electrode.

It is understood that the basic layout of the sensor elements (electrodes, traces, contacts) may be constructed in a number of ways, each of which results in at least one isolated electrode connected to at least one contact pad by one or more traces. Provided hereinafter are exemplary processes that result in an arrangement of sensor components resulting in the aforementioned architecture. These exemplary processes are provided as such, and are not intended to limit the embodiments disclosed herein.

Additional electrode and or traces and contact pads may be employed, for example, to provide a temperature sensor. Multiple analyte detecting “openings” may also be prepared on a single sensor. After formation of the openings over the electrodes, the electrochemical sensor component would be ready for receiving the analyte sensing membrane as discussed below.

### Electrode and Dielectric Surface Pretreatment

In one aspect, the fabrication process comprises treating the electroactive surface of the conductive material prior to application of the subsequent analyte sensing membrane. Surface treatments may include for example, chemical, gas plasma or laser treatment of at least a portion of the electroactive surface. By way of example, the electrodes may be chemically or covalently contacted with one or more adhesion promoting agents. Adhesion promoting agents may include for example, aminoalkylalkoxylsilanes, epoxyalkylalkoxylsilanes, and the like. For examples, one or more of the electrodes may be chemically or covalently contacted with a solution containing 3-glycidoxypropyltrimethoxysilane. Alternatively, the electrode surface may be contacted with a gas plasma, for example, an oxygen plasma for a time, concentration and at a power sufficient to improve the electrical response of the sensor. Other plasma gases may be used such as air, nitrogen, ammonia, carbon dioxide, water and combinations thereof.

In another aspect, the fabrication process comprises treating the surface of the dielectric material prior to application of the subsequent analyte sensing membrane. Surface treatments may include for example, physical, chemical or combinations of physical and/or covalent/non-covalent, and/or ionic bonding treatments. By way of example, physical treatments may be sanding, grinding, etching or other surface roughening methods to increase the surface area of at least a portion of the dielectric surface. By way of example, chemical treatments may include chemical, gas plasma, or laser exposure of at least a portion of the dielectric surface. Thus, the surface of the dielectric material may be chemically or covalently contacted with one or more adhesion promoting agents. Adhesion promoting agents may include for example, aminoalkylalkoxylsilanes, epoxyalkylalkoxylsilanes and the like. For examples, one or more of the electrodes may be chemically or covalently contacted with a solution containing 3-glycidoxypropyltrimethoxysilane. Alternatively, the surface of the dielectric material may be contacted with a gas plasma, for example, an oxygen plasma for a time, concentration and at a power sufficient to improve the adhesion of the analyte sensing membrane. Other plasma gases may be used such as air, nitrogen, ammonia, carbon dioxide, water and combinations thereof. Covalent coupling of the analyte sensing membrane to the plasma treated surface of the dielectric material may be performed using known coupling methods, for example, 1-ethyl-3(3-dimethyl aminopropyl)carbodiimide hydrochloride (EDC) or N-hydroxysuccinimide or other water-soluble carbodiimides, and may be employed with enhancers such as N-hydroxysulfosuccinimide (sulfo-NHS), although other suitable enhancers, such as N-hydroxysuccinimide (NHS), can alternatively be used. Thus, in one aspect, the surface of one dielectric material may be different from the surface of another dielectric material used for fabricating the sensor.

### Interference Layer

In one aspect, the fabrication process comprises the deposition of an interference layer to prevent or reduce migration of chemical species through the analyte sensing membrane. Interferents may be molecules or other species that may be reduced or oxidized at the electrochemically reactive surfaces of the sensor, either directly or via an electron transfer agent, to produce a false positive analyte signal (e.g., a non-analyte-related signal). This false positive signal generally causes the subject's analyte concentration to appear higher than the true analyte concentration. For example, in a hypoglycemic situation, where the subject has ingested an interferent (e.g., acetaminophen), the artificially high glucose signal may lead the subject or health care provider to believe that they are euglycemic or, in some cases, hyperglycemic. As a result, the subject or health care provider may make inappropriate or incorrect treatment decisions.

In one aspect, the fabrication process comprises includes depositing an interference layer that substantially restricts or eliminates the passage there through of one or more interfering species. Interfering species for a glucose sensor include, for example, acetaminophen, ascorbic acid, bilirubin, cholesterol, creatinine, dopamine, ephedrine, ibuprofen, L-dopa, methyl dopa, salicylate, tetracycline, tolazamide, tolbutamide, triglycerides, urea and uric acid. The interference layer may be less permeable to one or more of the interfering species than to a target analyte species.

In one aspect, the interference layer is formed from one or more cellulosic derivatives. In one aspect, mixed ester cellulosic derivatives may be used, for example, cellulose acetate butyrate, cellulose acetate phthalate, cellulose acetate propionate, cellulose acetate trimellitate, as well as their copolymers and terpolymers, with other cellulosic or non-cellulosic monomers, including cross-linked variations of the above. Other polymers, such as polymeric polysaccharides having similar properties to cellulosic derivatives, may be used as an interference material or in combination with the above cellulosic derivatives. Other esters of cellulose may be blended with the mixed ester cellulosic derivatives.

The dispensing of the interference material may be performed using any known thin film technique. For example, the interference material may be dispensed into the well of the electrochemical sensor component by micro-pipetting, spraying, casting, coating, or dipping directly to the electroactive surface(s). Two, three or more layers of interference material may be formed by the sequential application and curing and/or drying of the casting solution. In one aspect, no interference layer is used.

### Enzyme Layer

In one aspect, the fabrication process comprises depositing an analyte sensing membrane comprising an enzyme layer. The enzyme layer may comprise a hydrophilic polymer. It has been surprisingly found that the configuration where the enzyme layer is deposited directly onto at least a portion of the interference layer may substantially eliminate the need for an intervening layer between the interference layer and the enzyme layer while still providing a rapid and accurate signal representative of the analyte. In one aspect, the enzyme layer comprises an enzyme deposited directly onto at least a portion of the interference layer.

In one aspect, the enzyme layer comprises a enzyme and a hydrophilic polymer selected from poly-N-vinylpyrrolidone (PVP), poly-N-vinyl-3-ethyl-2-pyrrolidone, poly-N-vinyl-4,5-dimethyl-2-pyrrolidone, polyacrylamide, poly-N,N-dimethylacrylamide, polyvinyl alcohol, polymers with pendent ionizable groups (polyelectrolytes) and copolymers thereof. Preferably, the enzyme layer comprises poly-N-vinylpyrrolidone. Most preferably, the enzyme layer comprises glucose oxidase, poly-N-vinylpyrrolidone and optionally an amount of crosslinking agent sufficient to immobilize the enzyme.

The molecular weight of the hydrophilic polymer of the enzyme layer is preferably such that fugitive species are prevented or substantially inhibited from leaving the sensor environment and more particularly, fugitive species are prevented or substantially inhibited from leaving the enzyme's environment when the sensor is initially deployed.

The hydrophilic polymer of the enzyme layer may further include at least one protein and/or natural or synthetic material. For example, the enzyme layer may further include, for example, serum albumins, polyallylamines, polyamines and the like, as well as combination thereof.

The enzyme of the enzyme layer is preferably immobilized in the sensor. The enzyme may be encapsulated within the hydrophilic polymer and may be cross-linked or otherwise immobilized therein. The enzyme may be cross-linked or otherwise immobilized optionally together with at least one protein and/or natural or synthetic material. In one aspect, the hydrophilic polymer-enzyme composition comprises glucose oxidase, bovine serum albumin, and poly-N-vinylpyrrolidone. The composition may further include a cross-linking agent, for example, a dialdehyde such as glutaraldehdye, to cross-link or otherwise immobilize the components of the composition.

In one aspect, other proteins or natural or synthetic materials may be substantially excluded from the hydrophilic polymer-enzyme composition of the enzyme layer. For example, the hydrophilic polymer-enzyme composition may be substantially free of bovine serum albumin Bovine albumin-free compositions may be desirable for meeting various governmental regulatory requirements. Thus, in one aspect, the enzyme layer comprises glucose oxidase and a sufficient amount of cross-linking agent, for example, a dialdehyde such as glutaraldehdye, to cross-link or otherwise immobilize the enzyme. In other aspect, the enzyme layer comprises glucose oxidase, poly-N-vinylpyrrolidone and a sufficient amount of cross-linking agent to cross-link or otherwise immobilize the enzyme.

The enzyme layer thickness may be from about 0.05 microns or less to about 20 microns or more, more preferably from about 0.05, 0.1, 0.15, 0.2, 0.25, 0.3, 0.35, 0.4, 0.45, 0.5, 1, 1.5, 2, 2.5, 3, or 3.5 microns to about 4, 5, 6, 7, 8, 9, 10, 11, 12, 13, 14, 15, 16, 17, 18, 19, or 19.5 microns. Preferably, the enzyme layer is deposited by nano-dispensing, spray or dip coating, however, other methods of forming the enzyme layer may be used. The enzyme layer may be formed by micro-pipetting, dip coating and/or spray coating one or more layers at a predetermined concentration of the coating solution, insertion rate, dwell time, withdrawal rate, and/or desired thickness.

### Flux Limiting Layer

In one aspect, the fabrication process comprises disposing a flux limiting layer over the subsequent layers described above, where the flux limiting layer alters or changes the rate of flux of one or more of the analytes of interest. Although the following description is directed to a flux limiting layer for an electrochemical glucose sensor, the flux limiting layer may be modified for other analytes and co-reactants as well.

In one aspect, the flux limiting layer comprises a semi-permeable material that controls the flux of oxygen and glucose to the underlying enzyme layer, preferably providing oxygen in a non-rate-limiting excess. As a result, the upper limit of linearity of glucose measurement is extended to a much higher value than that which is achieved without the flux limiting layer. In one embodiment, the flux limiting layer exhibits an oxygen to glucose permeability ratio of from about 50:1 or less to about 400:1 or more, preferably about 200:1. Other flux limiting layers may be used or combined, such as a membrane with both hydrophilic and hydrophobic polymeric regions, to control the diffusion of analyte and optionally co-analyte to an analyte sensor. For example, a suitable membrane may include a hydrophobic polymer matrix component such as a polyurethane, or polyetherurethaneurea. In one aspect, the material that forms the basis of the hydrophobic matrix of the layer can be any of those known in the art as appropriate for use as membranes in sensor devices and as having sufficient permeability to allow relevant compounds to pass through it, for example, to allow an oxygen molecule to pass through the layer from the sample under examination in order to reach the active enzyme or electrochemical electrodes. For example, non-polyurethane type layers such as vinyl polymers, polyethers, polyesters, polyamides, inorganic polymers such as polysiloxanes and polycarbosiloxanes, natural polymers such as cellulosic and protein based materials, and mixtures or combinations thereof may be used.

In one aspect, the flux limiting layer comprises a polyethylene oxide component. For example, a hydrophobic-hydrophilic copolymer comprising polyethylene oxide is a polyurethane polymer that includes about 20% hydrophilic polyethylene oxide. The polyethylene oxide portions of the copolymer are thermodynamically driven to separate from the hydrophobic portions (e.g., the urethane portions) of the copolymer and the hydrophobic polymer component. The 20% polyethylene oxide-based soft segment portion of the copolymer used to form the final blend affects the water pick-up and subsequent glucose permeability of the membrane.

In one aspect, the flux limiting layer substantially excludes condensation polymers such as silicone and urethane polymers and/or copolymers or blends thereof. Such excluded condensation polymers typically contain residual heavy metal catalytic material that may otherwise be toxic if leached and/or difficult to completely remove, thus rendering their use in such sensors undesirable for safety and/or cost.

In another aspect, the material that comprises the flux limiting layer may be a vinyl polymer appropriate for use in sensor devices having sufficient permeability to allow relevant compounds to pass through it, for example, to allow an oxygen molecule to pass through in order to reach the active enzyme or electrochemical electrodes. Examples of materials which may be used to make the flux limiting layer include vinyl polymers having vinyl ester monomeric units. In a preferred embodiment, a flux limiting layer comprises poly ethylene vinyl acetate (EVA polymer). In other aspects, the flux limiting layer comprises poly(methylmethacrylate-co-butyl methacrylate) blended with the EVA polymer. The EVA polymer or its blends may be cross-linked, for example, with diglycidyl ether. Films of EVA are very elastomeric, which may provide resiliency to the sensor for navigating a tortuous path, for example, into venous anatomy.

The EVA polymer may be provided from a source having a composition anywhere from about 9 wt % vinyl acetate (EVA-9) to about 40 wt % vinyl acetate (EVA-40). The EVA polymer is preferably dissolved in a solvent for dispensing into the well formed in the sensor or sensor assembly. The solvent should be chosen for its ability to dissolve EVA polymer, to promote adhesion to the sensor substrate and enzyme electrode, and to form a solution that may be effectively dispensed (e.g. micro-pipette, spray, dip coating, spin coating). Solvents such as cyclohexanone, paraxylene, and tetrahydrofuran may be suitable for this purpose. The solution may include about 0.5 wt % to about 8.0 wt % of the EVA polymer. In addition, the solvent should be sufficiently volatile to evaporate without undue agitation to prevent issues with the underlying enzyme, but not so volatile as to create problems with the dispensing process. In a preferred embodiment, the vinyl acetate component of the flux limiting layer includes about 20% vinyl acetate. In preferred embodiments, the flux limiting layer is deposited onto the enzyme layer to yield a layer thickness of from about 0.05 microns or less to about 20 microns or more, more preferably from about 0.05, 0.1, 0.15, 0.2, 0.25, 0.3, 0.35, 0.4, 0.45, 0.5, 1, 1.5, 2, 2.5, 3, or 3.5 microns to about 4, 5, 6, 7, 8, 9, 10, 11, 12, 13, 14, 15, 16, 17, 18, 19, or 19.5 microns, and more preferably still from about 5, 5.5 or 6 microns to about 6.5, 7, 7.5 or 8 microns. The flux limiting layer may be deposited onto the enzyme layer, for example, by spray coating or dip coating. In one aspect, the flux limiting layer is deposited on the enzyme layer by coating a solution of from about 1 wt. % to about 5 wt. % EVA polymer and from about 95 wt. % to about 99 wt. % solvent.

In one aspect, an electrochemical analyte sensor fabricated as described above is provided comprising an isolated electrode formed on an inorganic substrate, the electrode isolated between first and second polymer layers arranged on the inorganic substrate, the sensor being encapsulated in a flux limiting layer covering the analyte sensing membrane layers and the underlying isolated electrode. Thus, the flux limiting layer formed from an EVA polymer may serve as a flux limiter at the top of the electrode, but also serve as a sealant or encapsulant at the enzyme/electrode boundary and at the electrode/dielectric boundary.

### Additional Layers

The fabrication process of the electrochemical sensor described herein may further comprise depositing additional layers that provide specific functions for improving the performance of the sensor. For example, additional layers may provide for manipulation of various biological processes when used in vivo in a subject. The additional layer may provide shielding of external electrical or magnetic fields (EMF or RF). The additional layers may be adjacent to or cover at least a part of the flux limiting layer. The additional layers may include hydrophilic polymer membranes, polymers with pendent ionizable groups (polyelectrolytes) and copolymers thereof.

In one aspect, the additional layer is a hydrophilic polymer membrane that is essentially water-insoluble. As used herein, the phase “water-insoluble” refers to a hydrophilic polymer membrane that, when exposed to an excess of water, may swell or otherwise absorb water to an equilibrium volume, but does not dissolve into the aqueous solution. As such, a water-insoluble material generally maintains its original physical structure during the absorption of the water and, thus, must have sufficient physical integrity to resist flow and diffusion away or with its environment. As used herein, a material will be considered to be water insoluble when it substantially resists dissolution in excess water to form a solution, and/or losing its initial, film form and resists becoming essentially molecularly dispersed throughout the water solution. In one aspect, the hydrophilic polymer membrane is coated over the flux limiting layer and will not degrade or diffuse away from the flux limiting layer during use, for example, during in vivo use.

### Bioactive Agent Layer and Active Agents

In some alternative embodiments, a bioactive agent layer may be used. The bioactive agent layer may be optionally incorporated into any of the above described layers, such that the bioactive diffuses out into the biological environment adjacent to the sensor. Additionally or alternately, a bioactive agent may be administered locally at the exit-site or implantation-site. Suitable bioactive agents include active agents that modify the subject's tissue response to any of the sensor or components thereof. For example, bioactive agents may be selected from anti-inflammatory agents, anti-infective agents, anesthetics, inflammatory agents, growth factors, immunosuppressive agents, antiplatelet agents, anti-coagulants, anti-proliferates, ACE inhibitors, cytotoxic agents, anti-barrier cell compounds, anti-vascularization-inducing compounds, anti-sense molecules, or mixtures thereof. The bioactive agent layer may be employed in the analyte sensor to prevent coagulation within or on the sensor (e.g., within or on the catheter or within or on the sensor). Suitable bioactive agents that function as anticoagulants for incorporation into or on the sensor include, but are not limited to, vitamin K antagonists (e.g., Acenocoumarol, Clorindione, Dicumarol (Dicoumarol), Diphenadione, Ethyl biscoumacetate, Phenprocoumon, Phenindione, Tioclomarol, or Warfarin), heparin group anticoagulants (e.g., Platelet aggregation inhibitors: Antithrombin III, Bemiparin, Dalteparin, Danaparoid, Enoxaparin, Heparin, Nadroparin, Parnaparin, Reviparin, Sulodexide, Tinzaparin), other platelet aggregation inhibitors (e.g., Abciximab, Acetylsalicylic acid (Aspirin), Aloxiprin, Beraprost, Ditazole, Carbasalate calcium, Cloricromen, Clopidogrel, Dipyridamole, Epoprostenol, Eptifibatide, Indobufen, Iloprost, Picotamide, Ticlopidine, Tirofiban, Treprostinil, Triflusal), enzymes (e.g., Alteplase, Ancrod, Anistreplase, Brinase, Drotrecogin alfa, Fibrinolysin, Protein C, Reteplase, Saruplase, Streptokinase, Tenecteplase, Urokinase), direct thrombin inhibitors (e.g., Argatroban, Bivalirudin, Desirudin, Lepirudin, Melagatran, Ximelagatran, other antithrombotics (e.g., Dabigatran, Defibrotide, Dermatan sulfate, Fondaparinux, Rivaroxaban) and the like. In one aspect, the bioactive agent layer comprises at least one active agent selected from the group consisting of vitamin K antagonists, heparin group anticoagulants, platelet aggregation inhibitors, enzymes, direct thrombin inhibitors, Dabigatran, Defibrotide, Dermatan sulfate, Fondaparinux, and Rivaroxaban.

### Flexible Substrate Sensor Assembly

In one aspect, the method disclosed herein further includes the step of mounting, soldering, and/or coupling one or more of the electrodes or one or more of the contacts of the microfabricated sensor or sensor assembly described above, to a flexible substrate, such as a flex circuit or to a printed circuit board (PCB). In one aspect, a flex circuit with corresponding contact portions electrically couples the microfabricated sensor to a controller via one or more of the sensor contact pads.

In one aspect, the above microfabricated analyte sensor assembly may be configured for intravenous insertion to a vascular system of a subject. In one aspect, in order to accommodate the sensor within the confined space of a device suitable for intravenous insertion, the sensor assembly is assembled onto the flexible circuit. In another aspect, microfabricated analyte sensor assembly can be configured to a PCB board as part of a housing, for example, of an infusion coupler, such that the sensor assembly is ex-vivo.

Medical devices adaptable to the sensor assembly as described above include, but are not limited to a central venous catheter (CVC), a pulmonary artery catheter (PAC), a probe for insertion through a CVC or PAC or through a peripheral IV catheter, a peripherally inserted catheter (PICC), Swan-Ganz catheter, an introducer or an attachment to a Venous Arterial blood Management Protection (VAMP) system. Any size/type of Central Venous Catheter (CVC) or intravenous devices may be used or adapted for use with the sensor assembly.

For the foregoing discussion, the implementation of the sensor or sensor assembly is disclosed as being placed within a catheter, however, other devices as described above are envisaged and incorporated in aspects of the embodiments disclosed herein. The sensor assembly will preferably be applied to the catheter so as to be flush with the OD of the catheter tubing. This may be accomplished, for example, by thermally deforming the OD of the tubing to provide a recess for the sensor. The sensor assembly may be bonded in place, and sealed with an adhesive (e.g., urethane, 2-part epoxy, acrylic, etc.) that will resist bending/peeling, and adhere to the urethane CVC tubing, as well as the materials of the sensor. Small diameter electrical wires may be attached to the sensor assembly by soldering, resistance welding, or conductive epoxy. These wires may travel from the proximal end of the sensor, through one of the catheter lumens, and then to the proximal end of the catheter. At this point, the wires may be soldered to an electrical connector.

The sensor assembly as disclosed herein can be added to a catheter in a variety of ways. For example, an opening may be provided in the catheter body and a sensor or sensor assembly may be mounted inside the lumen at the opening so that the sensor would have direct blood contact. In one aspect, the sensor or sensor assembly may be positioned proximal to all the infusion ports of the catheter. In this configuration, the sensor would be prevented from or minimized in measuring otherwise detectable infusate concentration instead of the blood concentration of the analyte. Another aspect, an attachment method may be an indentation on the outside of the catheter body and to secure the sensor inside the indentation. This may have the added advantage of partially isolating the sensor from the temperature effects of any added infusate. Each end of the recess may have a skived opening to 1) secure the distal end of the sensor and 2) allow the lumen to carry the sensor wires to the connector at the proximal end of the catheter.

Preferably, the location of the sensor assembly in the catheter will be proximal (upstream) of any infusion ports to prevent or minimize IV solutions from affecting analyte measurements. In one aspect, the sensor assembly may be about 2.0 mm or more proximal to any of the infusion ports of the catheter.

In another aspect, the sensor assembly may be configured such that flushing of the catheter (e.g., saline solution) may be employed in order to allow the sensor assembly to be cleared of any material that may interfere with its function.

### Sterilization of the Sensor or Sensor Assembly

Generally, the sensor or the sensor assembly as well as the device that the sensor is adapted to are sterilized before use. In one aspect, the fabrication process includes the sterilization of the sensor. Sterilization may be achieved using aseptic manufacturing, radiation (e.g., electron beam or gamma radiation), ethylene oxide or flash-UV sterilization, or other means know in the art.

Disposable portions, if any, of the sensor, sensor assembly or devices adapted to receive and contain the sensor preferably will be sterilized, for example using e-beam or gamma radiation or other know methods. The fully assembled device or any of the disposable components may be packaged inside a sealed container or pouch.

Central line catheters may be known in the art and typically used in the Intensive Care Unit (ICU)/Emergency Room of a hospital to deliver medications through one or more lumens of the catheter to the patient (different lumens for different medications). A central line catheter is typically connected to an infusion device (e.g., infusion pump, IV drip, or syringe port) on one end and the other end inserted in one of the main arteries or veins near the patient's heart to deliver the medications. The infusion device delivers medications, such as, but not limited to, saline, drugs, vitamins, medication, proteins, peptides, insulin, neural transmitters, or the like, as needed to the patient. In alternative embodiments, the central line catheter may be used in any body space or vessel such as intraperitoneal areas, lymph glands, the subcutaneous, the lungs, the digestive tract, or the like and may determine the analyte or therapy in body fluids other than blood. The central line catheter may be a double lumen catheter. In one aspect, an analyte sensor is built into one lumen of a central line catheter and is used for determining characteristic levels in the blood and/or bodily fluids of the user. However, it will be recognized that further embodiments may be used to determine the levels of other agents, characteristics or compositions, such as hormones, cholesterol, medications, concentrations, viral loads (e.g., HIV), or the like. Therefore, although aspects disclosed herein may be primarily described in the context of glucose sensors used in the treatment of diabetes/diabetic symptoms, the aspects disclosed may be applicable to a wide variety of patient treatment programs where a physiological characteristic is monitored in an ICU, including but not limited to blood gases, pH, temperature and other analytes of interest in the vascular system.

In another aspect, a method of intravenously measuring an analyte in a subject is provided. The method comprises providing a catheter comprising the sensor assembly as described herein and introducing the catheter into the vascular system of a subject. The method further comprises measuring an analyte of interest.

The above description discloses several methods and materials. These descriptions are susceptible to modifications in the methods and materials, as well as alterations in the fabrication methods and equipment. Such modifications will become apparent to those skilled in the art from a consideration of this disclosure or practice of the disclosure. Consequently, it is not intended that this disclosure be limited to the specific embodiments disclosed herein, but that it cover all modifications and alternatives coming within the true scope and spirit of the claims.

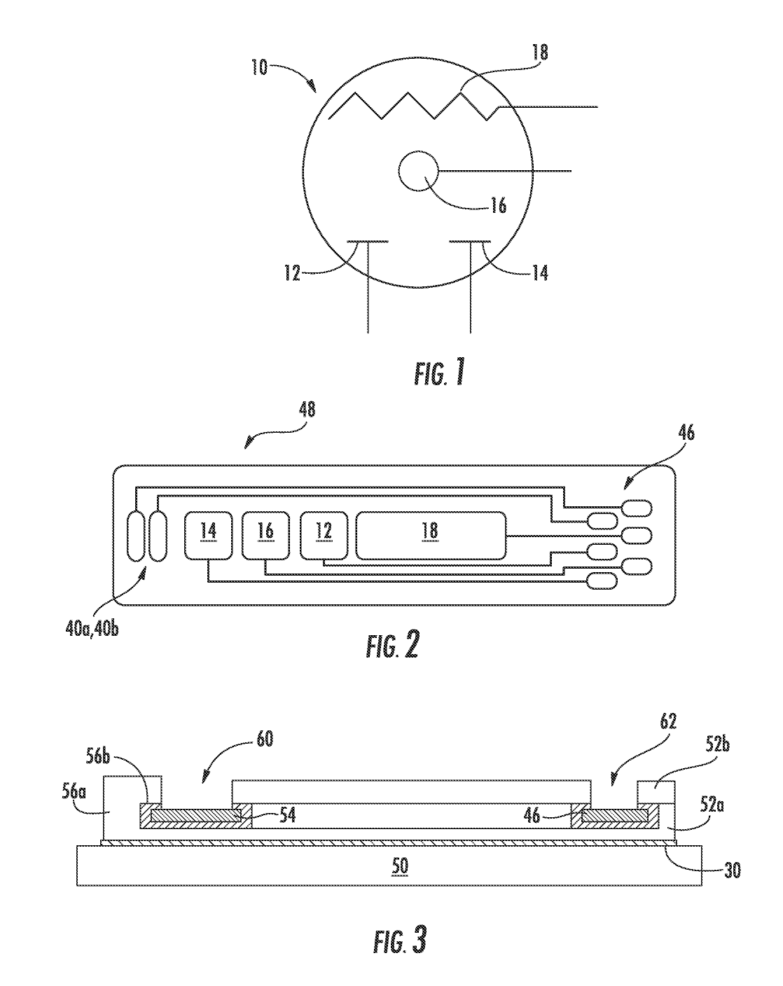

Referring now to the Figures, FIG. 1 is a schematic diagram of an exemplary electrochemical analyte sensor, and specifically, a basic amperometric analyte sensor. The depicted analyte sensor comprises two working electrodes: a first working electrode 12 and a second working electrode 14 (the second working electrode is sometimes referred to as the blank electrode). In some embodiments, the analyte sensor is a glucose sensor, in which case the first working electrode 12 may immobilize a glucose oxidase enzyme. The first working electrode 12 is typically an enzyme electrode either containing or immobilizing an enzyme membrane. The second working electrode 14 is typically identical in all respects to the first working electrode 12, except that it either does not contain an enzyme or contains an inactivated enzyme. The analyte sensor also includes a reference electrode 16 and a counter electrode 18. The reference electrode 16 establishes a fixed potential from which the potential of the working electrodes 12 and 14 are established. In order for the reference electrode 16 to function properly, no current must flow through it. The counter electrode 18 is used to conduct current in or out of the analyte sensor so as to balance the current generated by the working electrodes. The counter electrode 18 also provides a working area for conducting the majority of electrons produced from the oxidation chemistry back to the blood solution. Otherwise, excessive current may pass through the reference electrode 16 and reduce its service life. The four electrodes together are typically referred to as a cell. During operation, outputs from the working electrodes are monitored to determine the amount of an analyte of interest that is in the blood. Potentiometric analyte sensors operate in a similar manner to detect the amount of an analyte in a substance.

FIG. 2 illustrates an exemplary electrochemical sensor component fabricated in accordance with aspects disclosed and described herein. As illustrated, sensor 48 includes a first working electrode 12 and a second working (blank) electrode 14, a reference electrode 16, and a counter electrode 18. Each electrode is isolated in dielectric material and is connected to an isolated trace(s) leading to an isolated contact pad(s) 46. In this illustrated embodiment, the counter electrode 18 is dimensioned larger than the first and second working electrodes. The area of the counter electrode is generally made to be larger than the area of the working electrode such that the reaction on the counter electrode does not become a rate-determining step. In this illustrated embodiment, the working electrode is positioned between the counter electrode and reference electrode for optimization of the output signal. The sensor further comprises an isolated temperature sensor 40, which in this embodiment, is a thermistor comprising to electrodes 40a and 40b. The thermistor electrodes are also connected via traces to corresponding contact pads 46.

FIG. 3 illustrates the cross sectional view of an exemplary electrochemical sensor component fabricated in accordance with aspects disclosed and described herein. As illustrated, the partially fabricated sensor includes opening 60 positioned over an isolated electrode 54 formed of conductive material sandwiched between first and second dielectric polymer layers 52a and 52b, respectively, and optionally, adhesive layers 56a and 56b and opening 62 positioned over a contact pad 46. Release layer 30 is positioned between the inorganic substrate 50 and the dielectric material layer to provide for lift-off of the sensor component after fabrication.

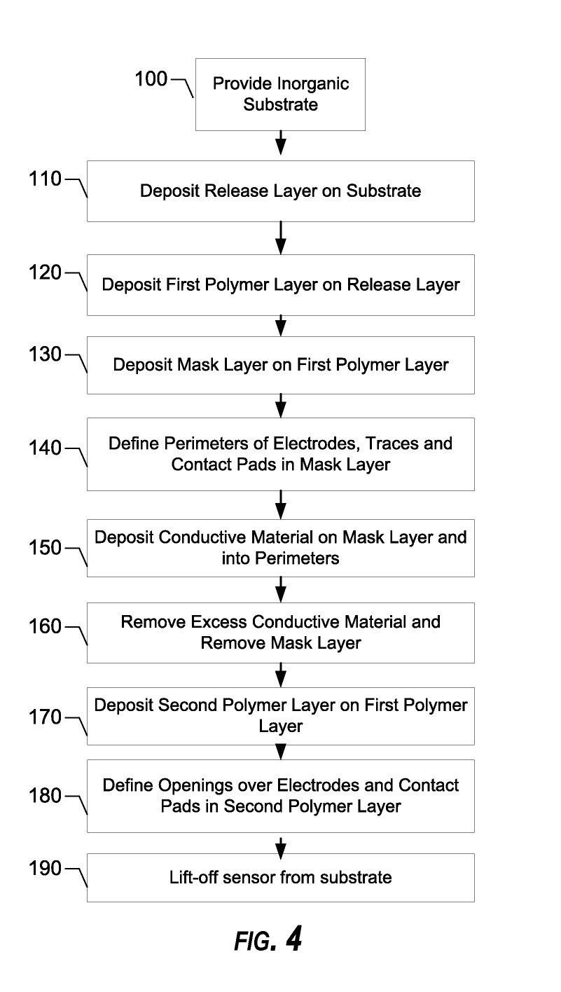

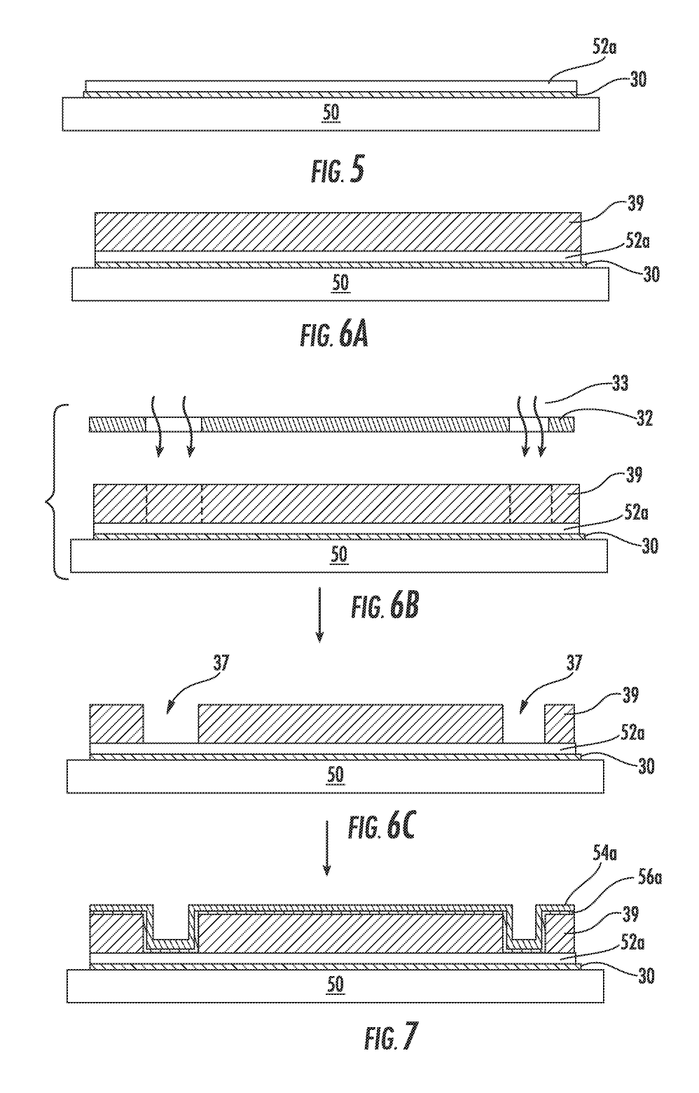

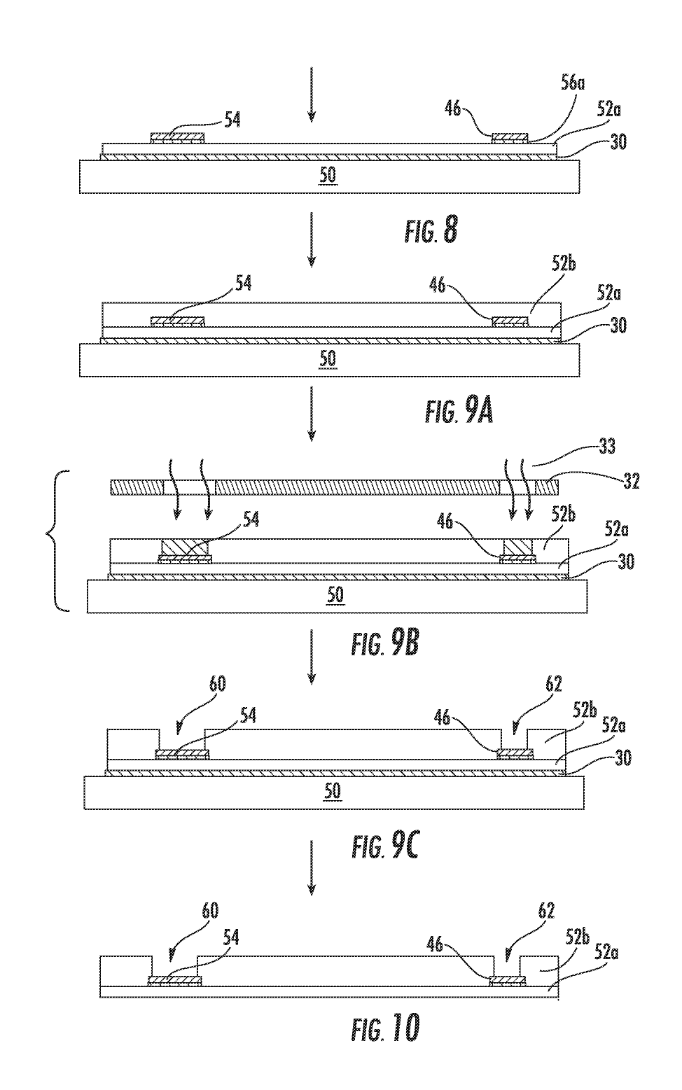

Referring to FIG. 4, a block diagram depicting a first embodiment of the sensor component fabrication corresponding to FIGS. 5-10 is provided. Thus, substrate 50 of semiconductor material, such as silicon is provided. (See block 100). Release layer 30 is deposited on the substrate (See block 110). A first dielectric polymer layer 52a is deposited on the release layer. (See block 120 and as shown in FIG. 5). A mask layer 39, such as a photoresist, is deposited on the first polymer coating, for example, by spin coating. (See block 130 and as shown in FIG. 6A). The mask layer is patterned/developed to provide perimeters for the deposition of the conductive material forming the electrodes and contact pads, as well as traces connecting the electrodes to the contact pads. (See block 140). Thus, as shown in FIG. 6B, actinic radiation 33 (e.g., x-ray, gamma, e-beam, DUV, UV, I-line, G-line, etc.) is passed thru patterned reticule 32 exposing mask layer 39. Development of the exposed areas, which in this example is by way of a positive photoresist, provides perimeters 37, as shown in FIG. 6C. Conductive material 54a (and optionally adhesive layer 56a) is then deposited into the perimeters defining the electrodes, traces and contact pads, such as by chemical vapor deposition (CVD) or plating (electro- or electroless). (See block 150 and as shown in FIG. 7). Excess conductive material is removed (e.g., using chemical polishing, lift-off or etching techniques), along with the mask layer providing isolated features (electrodes 54, traces (not shown) and contact pads 46). (See block 160 and as shown in FIG. 8). Second dielectric layer 52b of photosensitive material (e.g., polyimide or polyepoxide) is deposited over isolated conductive features and on first flexible dielectric layer. (See block 170 and as shown in FIG. 9A). The second flexible dielectric layer is patterned/developed to provide openings 60 and 62 over the conductive electrode 54 and contact pad 46, respectively. (See block 180 and as shown in FIG. 9B and FIG. 9C). Lift-off of the sensor from the substrate is achieved via release layer 30, which provides for separation of the first polymer layer from the substrate resulting in an electrochemical sensor component. (See block 190 and as shown in FIG. 10). Sensing chemistry may be introduced into the openings over one or more of the working electrodes (not shown) at this point, or optionally, prior to release of the substrate.

In one aspect, the process as described with reference to FIGS. 4-10 is performed without the use of release layer 30 or the release of the first polymer layer 52a from substrate 50 (not shown). In this aspect, the fabricated sensors may be die-cut from the inorganic substrate using known MEMS/IC manufacturing techniques.

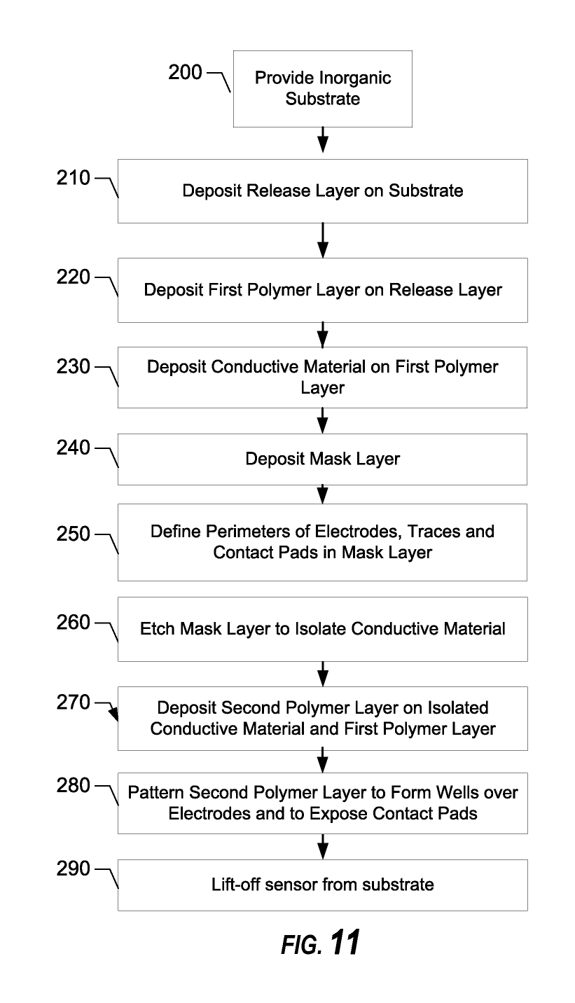

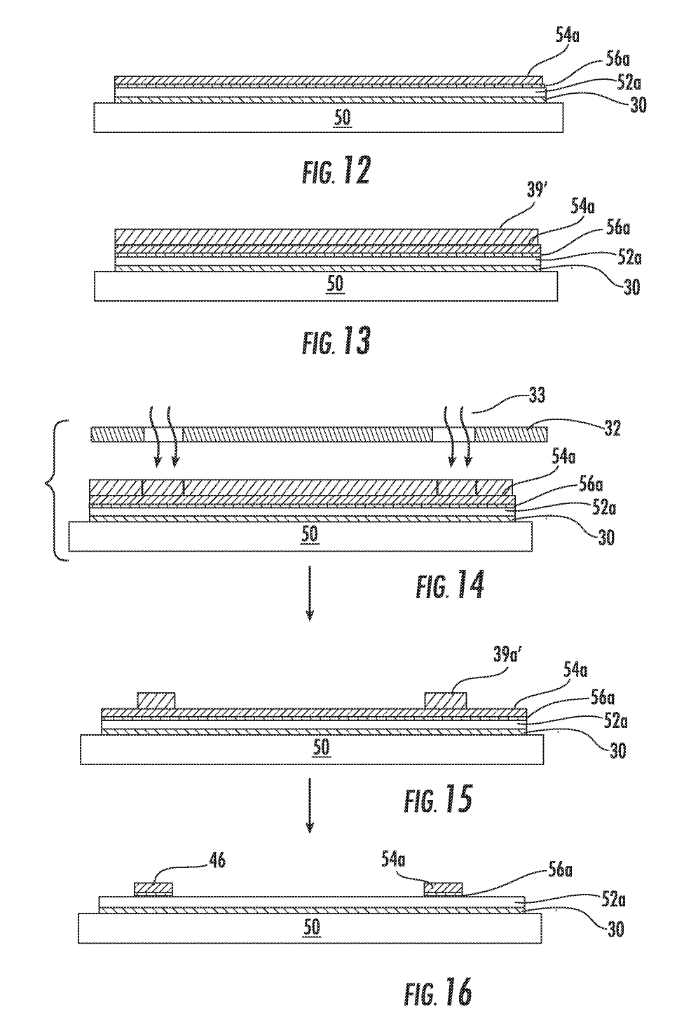

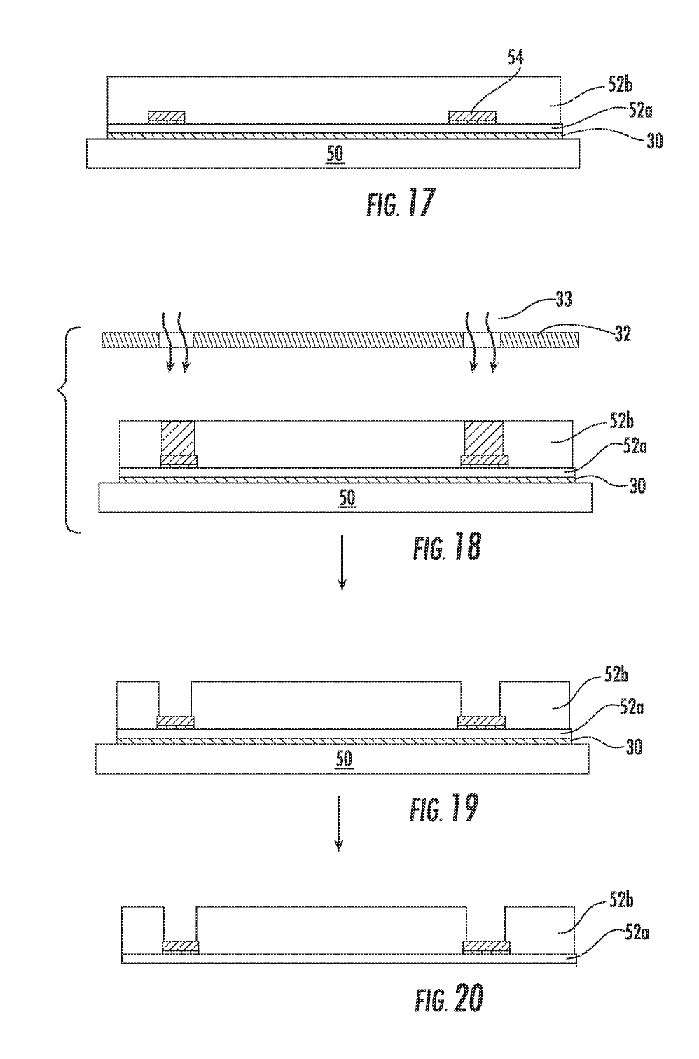

Referring now to FIG. 11, a block diagram depicting a second embodiment of the sensor fabrication corresponding to FIGS. 12-20 is provided. Thus, substrate 50 of semiconductor material, such as silicon is provided. (See block 200). Release layer 30 is deposited on the substrate (See block 210). A first polymer layer 52a is then applied onto the release layer such as by coating or deposition. (See block 220). Conductive material 54a (and optionally adhesive layer 56a, discussed below) is deposited on the first polymer layer. (See block 230 and as shown in FIG. 12). Mask layer 39 (over optional transition metal adhesion layer 56a) is deposited over the conductive material 54. (See block 240 and as shown in FIG. 13). Perimeters 39a′ for the conductive material are patterned into mask layer 39′. (See block 250 and as shown in FIGS. 14-15). Mask layer is etched along with excess conductive material to provide isolated (free standing) conductive electrodes (46, 54) on first polymer layer 52a. (See block 260 and as shown in FIG. 16). A second polymer layer 52b, such as a photosensitive dielectric material, is deposited on the isolated conductive material and first polymer coating, for example, by spin coating. (See block 270 and as shown in FIG. 17). The second polymer layer may be patterned/developed to provide openings over the electrodes and contact pads. (See block 280). Thus, as shown in FIG. 18, actinic radiation 33 (e.g., x-ray, gamma, e-beam, DUV, UV, I-line, G-line, etc.) is passed thru patterned reticule 32 exposing second dielectric layer 52b. Development of the exposed areas, which in this example is by way of a positive photoresist, provides openings 60 and 62, as shown in FIG. 19. The perimeters/openings may alternatively be formed using laser ablation techniques (with or without a reticule). Lift-off of the sensor from the substrate is achieved via release layer 30, which provides for separation of the first dielectric layer from the substrate resulting in an electrochemical sensor component. (See block 290 and as shown in FIG. 20). The sensing chemistry may be introduced into the openings over the working electrodes.

In one aspect, the process as described with reference to FIGS. 11-20 is performed without the use of release layer 30 or the release of the first dielectric layer 52a from substrate 50. In this aspect, the fabricated sensors may be individually separated from the inorganic substrate using known MEMS/IC manufacturing techniques, for example, die cutting or stamping.

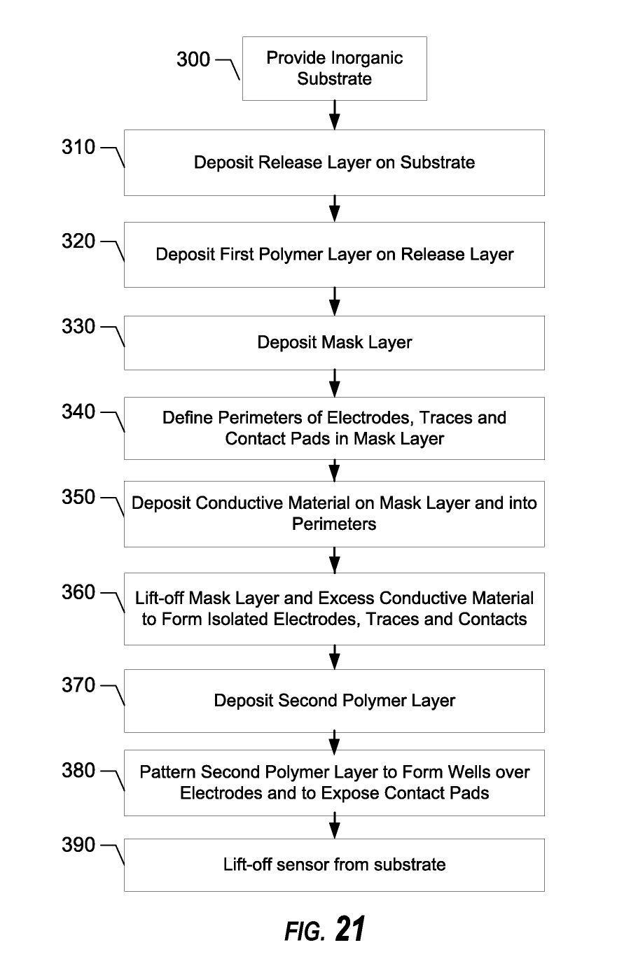

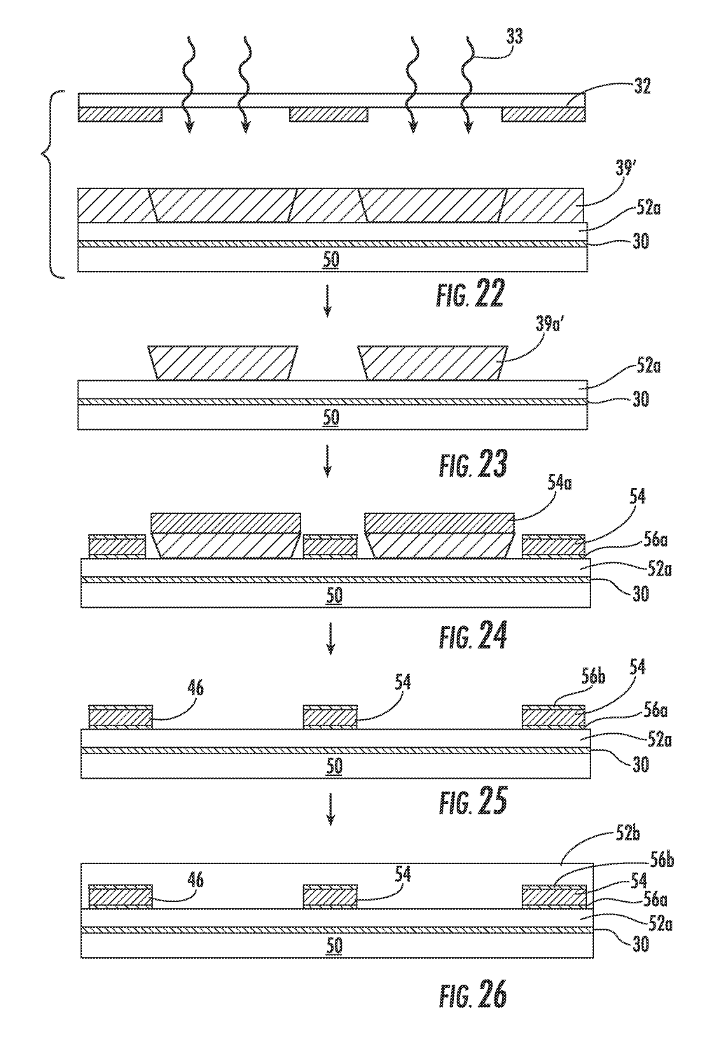

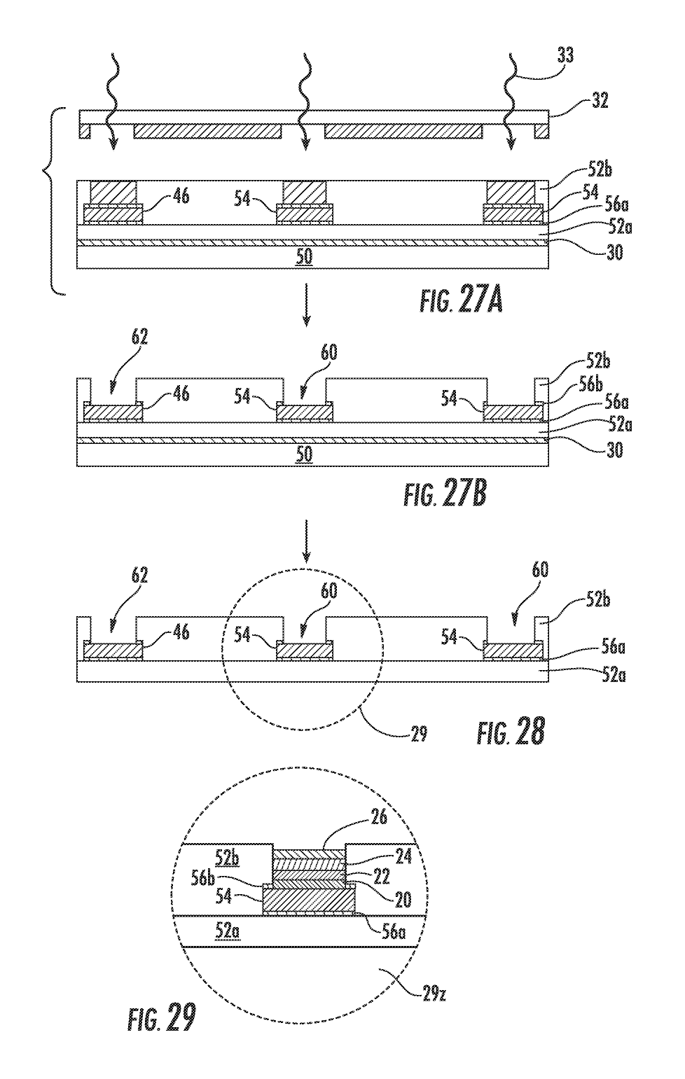

Referring now to FIG. 21, a block diagram depicting a third embodiment of the sensor fabrication corresponding to FIGS. 22-28 is provided. Thus, substrate 50 of semiconductor material, such as silicon is provided. (See block 300). Release layer 30 is deposited on the substrate (See block 310). First dielectric layer 52a is applied onto substrate 50, such as by spin coating. (See block 320). Photosensitive mask layer 39′ is then applied onto the release layer such as by coating or deposition. (See block 330). The mask layer is patterned and developed to provide perimeters for the electrodes, traces and contact pads. (See block 340). Thus, as shown in FIG. 22, actinic radiation 33 (e.g., x-ray, gamma, e-beam, DUV, UV, I-line, G-line, laser, etc.) is passed thru patterned reticule 32 exposing photosensitive mask layer 39′. Development of the un-exposed areas, which in this example is by way of negative photoresist mask layer 39′, provides perimeters 37 between features 39a′, as shown in FIG. 23. Optionally, a first transition metal adhesion layer 56a, such as a transition metal suitable for adhesion to the noble metal electrode metal and the dielectric, may be applied to the exposed first polymer layer. In one aspect, titanium metal, which is suitable for adhesion to gold metal and polyimide dielectrics, is used. Other transition metal/noble metal combinations can be used, which can be sputter coated or CVD or MOCVD applied. Conductive material 54a is deposited over mask layer 39′ and into perimeters formed on the first dielectric layer. (See block 350 and as shown in FIG. 24). Using lift-off techniques, the mask layer and excess conductive material are removed to provide isolated (free standing) conductive structures (46, 54) on the first polymer layer 52a. (See block 360 and as shown in FIG. 25). A photosensitive second dielectric layer 52b (and optional second transition metal adhesion layer 56b as described above) is deposited over the isolated conductive material and first polymer layer 52a. (See block 370 and as shown in FIG. 26). Exposure of photosensitive dielectric layer 52b to actinic radiation 33 and development provides openings 60 and 62 formed in the second dielectric layer 52b (and the optional second transition metal adhesion layer 56b, which may be the same or different as the first transition metal adhesion layer) exposing portions of isolated conductive material 54. (See block 380 and as shown in FIGS. 27A-B). The perimeters/openings may alternatively be formed using laser ablation techniques (with or without a reticule).

In order to improve the response to an electrochemically active species, in can be desirable to remove any excess adhesion layer material (e.g. second adhesion layer material 56b) from the isolated conductive material exposed by openings in the second dielectric layer, as shown in FIGS. 27A-B. In one aspect, when the transition metal adhesion layer 56b comprises a transition metal (e.g., titanium) and the exposed conductive material is a noble metal such as gold, platinum or palladium, etching of the adhesion layer has been surprisingly found to increase the response of the exposed noble metal over that of a similarly constructed device that has not been etched to remove the adhesion layer.

It is generally know that the removal of titanium from microfabricated parts is somewhat difficult due to the native titanium (di)oxide present. Solution based etching can be used to selectively etch the titanium transition metal along with the native oxides with little or no etching of the noble metal. Thus, in one aspect, hydrogen fluoride (HF) chemical etching can be used to remove the transition metal adhesion layer selectively from the noble metal conductive material exposed by an opening in an over-coated dielectric layer. While HF is a non-selective and isotropic etchant, some removal of the dielectric can be tolerated provided that the thickness of the dielectric is sufficient and the amount of residual transition metal adhesion layer is such that the electrical properties of the electrode are improved. As shown in FIGS. 3, 27B, 28, and 29, some overhang of the dielectric and transition metal adhesion layer 56b with the conductive material is generally desirable, for example, to avoid compromise of the dielectric layer and separation thereof from the conductive material as well as egress of material. It is desirable using HF etchant to minimize the lateral etching of the adhesion layer to avoid undercutting the interface of the dielectric/adhesion layer/noble metal in this over-hang structure.

In another embodiment, a non-HF etching method can be employed, such as inductively coupled plasma etching (ICP), ion beam etching (inclusive of chemically assisted and thermally assisted ICP) and reactive ion etching (RIE). Such etching methods are generally anisotropic, in that they tend to avoid lateral etching. As such, it may be preferred to employ such methods. In one aspect, ion beam etching (IBE) can be employed using generally known techniques. CF₄/O₂ gas mixtures, or other halogenated source gases with oxygen, can be used to remove native titanium oxides from the noble metal. Other examples of plasma gas mixtures suitable to etch titanium include CCl₄/O₂ with fluorine-containing gases, CCl₄/CCl₂F₂/O₂, Cl₂/BCl₃, Cl₂/N₂, CF₄, SiCl₄, SiCl₄/CF₄ and CHF₃, CF₄/O₂, and SF₆. Monitoring of the etching process can be used to minimize or prevent removal of the noble metal and/or the dielectric material. Examples of ion beam gases, e.g., “neutral ion beam” gases include the inert gases helium (He), neon (Ne), argon (Ar), krypton (Kr), xenon (Xe), radon (Rn), and mixtures thereof. In one aspect, an inert gas can be used in combination with nitrogen. In a preferred aspect, argon is used, alone or in combination with nitrogen.

Lift-off of the sensor from the substrate is achieved via release layer 30, which provides for separation of the first polymer layer from the substrate resulting in an electrochemical sensor component. (See block 390 and as shown in FIG. 28). The sensing chemistry may be introduced into the openings over one or more of the working electrodes as will now be described.

FIG. 29 is an exploded cross-sectional view of an exemplary well positioned over an electrode (e.g., a working electrode) of FIG. 28. Depending on the functionality of the electrode, an analyte sensing membrane is then applied to the exposed electrode in the well. For example, as shown in exploded view 29z, if the electrode is a working electrode, the analyte sensing membrane may be applied comprising: a hydrophilic layer 20; an interference layer 22; an enzyme layer 24; and a flux-limiting layer 26, each of the layers of the analyte sensing membrane (and optional additional layers such as a bioactive layer) having been described above. In certain aspects, interference layer 22 is not used. Methods of depositing the layers of the analyte sensing membrane include, for example, (micro)pipetting, casting, dip-coating, (micro)spray-coating, ink-jet spray coating, vapor coating and the like.

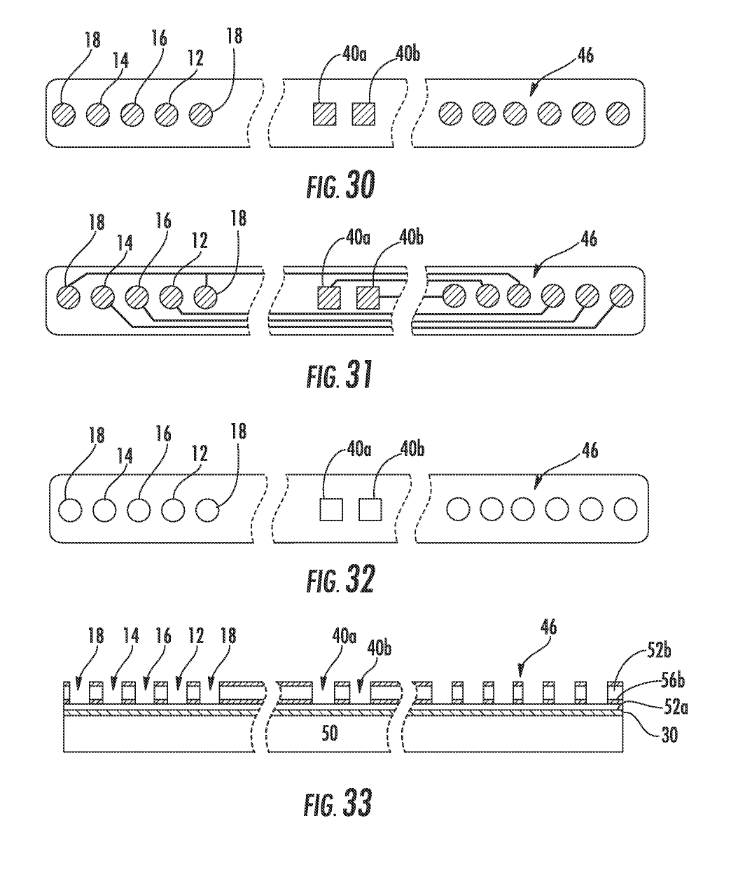

FIGS. 30-32 illustrate detailed views of sample sensor 70 architecture similar to the sensor architecture of FIG. 6A. Thus, top plan views of an exemplary fabrication process steps are described herein. FIG. 30 depicts the top plan view of isolated conductive features comprising first working electrode 12 and second working (blank) electrodes 14, reference electrode 16, counter electrode 18 and contact pads 46. Also provided are electrodes, 40a, 40b, for the temperature sensor. FIG. 31 illustrates electrical connection via traces between the contact pads and the electrodes. FIG. 32 depicts the top plan view of the isolated openings positioned over the electrodes contact pads 46 and thermistor 40a, 40b. FIG. 33 is a cross-sectional view of the openings of the sensor depicted in FIG. 32. Contact pads 46 are also illustrated. It is noted that FIGS. 30-32 illustrate only the electrodes, traces, and contact pads of the sensor. Membrane layers over the various electrodes are not illustrated.

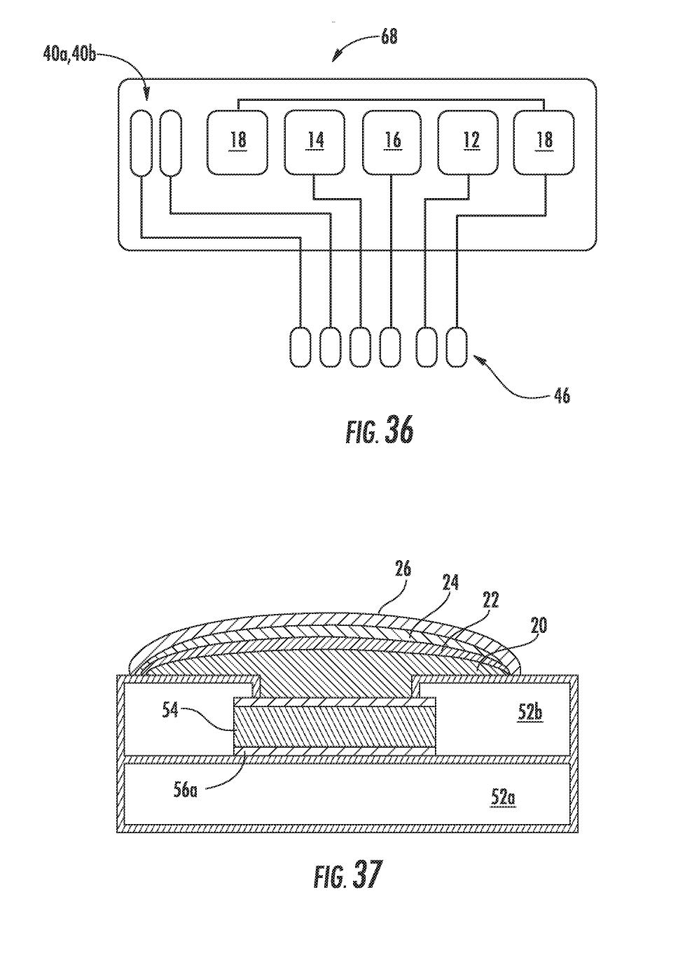

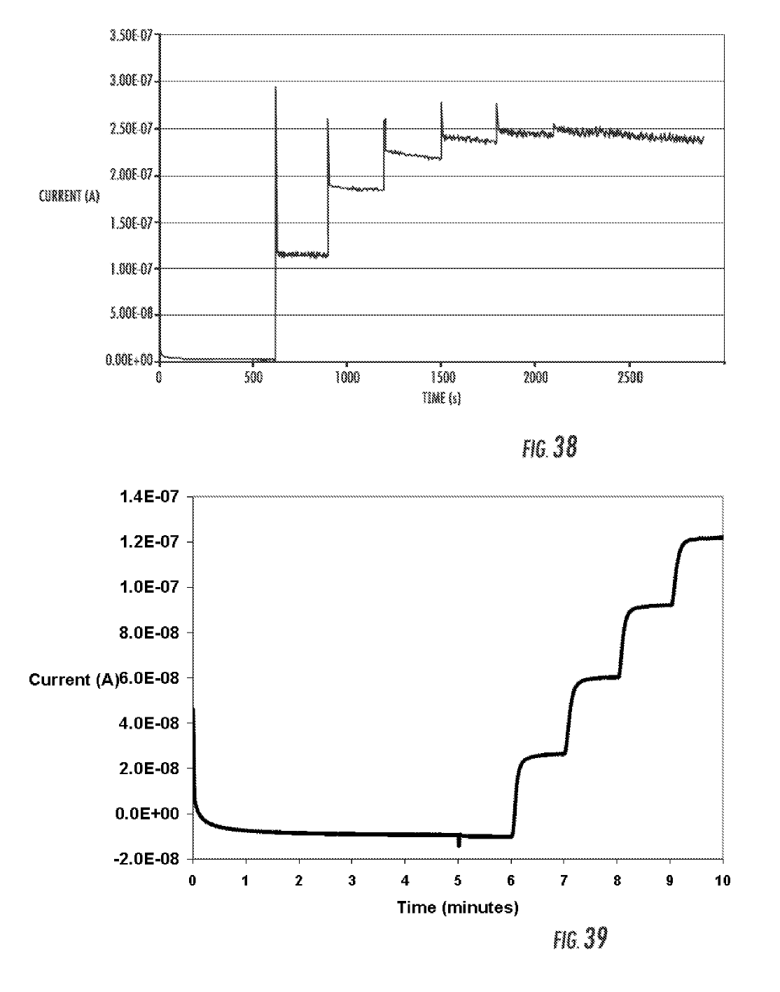

Referring now to FIGS. 34-36, illustrated are different structural/geometrical embodiments of the sensor structure. Other designs and layouts may be used. Thus, two smaller counter electrodes 18 are depicted in sensors 64, 66 and 68, as opposed to the larger single counter electrode as depicted in FIG. 2, while maintaining a larger surface area ratio between the counter electrode and working electrode. These sensor structures may be fabricated using the techniques described above. FIG. 37 represents an aspect of the analyte sensing membrane whereby the individual layers of the membrane are draped over the opening. In one aspect, (not shown) some or one of the layers (e.g., the flux-limiting layer) may be draped over the opening and underlying layers and/or may encapsulate the analyte sensing membrane to the dielectric layer.

### EXPERIMENTAL

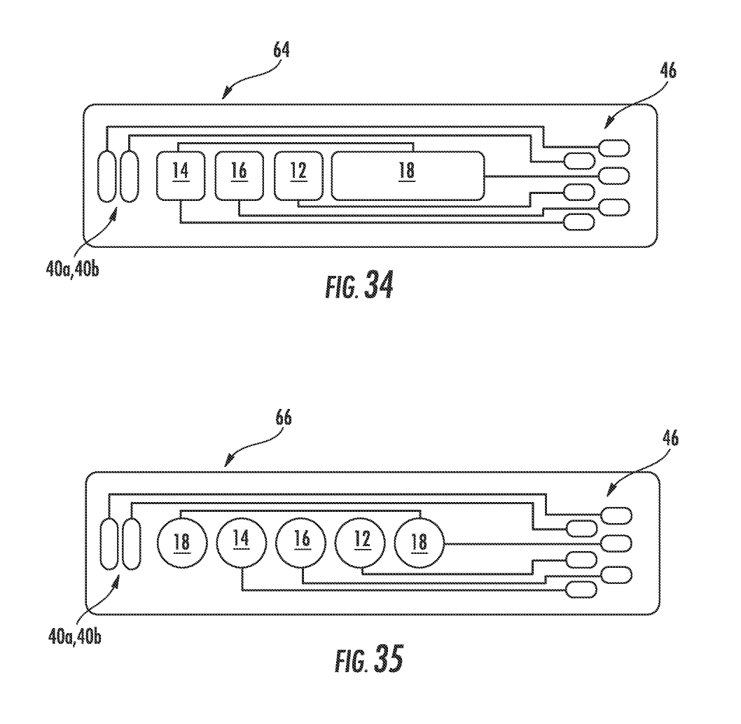

A thin-film sensor component was fabricated by micromachining/IC processing on a silicon wafer substrate having an architecture similar to that depicted in FIG. 35 except no temperature electrodes were employed. Thus, silicon oxide (500 nm thickness) was sputtered as a release layer on a silicon wafer. A 10 μm layer of first dielectric material (polyimide precursor PI-2611, HD Microsystems) was applied on top of the silicon oxide by spin-coating and cured at 300° C. for 40 minutes in a nitrogen atmosphere. Layers of titanium (˜500 Å)-platinum (˜500 nm)-titanium (˜500 Å) were sputtered sequentially and patterned for metal electrodes, pads and conductive traces. The titanium layers enhanced the adhesion between the polyimide and the platinum layer. A second dielectric layer of polyimide (5 μm thickness) was spin-coated and cured on the patterned metal layers. Silicon oxide (˜500 nm thickness) etch stop was sputtered onto the polyimide and patterned using a photoresist layer to define openings for electrodes, contact pads and sensor outline. Etching of the second dielectric layer with patterned SiO₂ etch stop with oxygen-plasma RIE provided openings exposing the electrodes and contact pads. Finally, the sensor structure was released from silicon wafer by wet etching in HF solution (20% HF in 80% DI water. Alternatively, 30% KOH at 50° C. can be used). A thin-layer of silver (Ag) was electroplated on the reference electrode 16. Silver was then converted to silver/silver chloride (Ag/AgCl) electrochemically. There was no iron chloride or silver nitrate applied to the reference electrodes. As an initial step, hydrogen peroxide activity was evaluated on the electrodes prior to application of the analyte sensing membrane. An analyte sensing membrane was deposited comprising CAB/GOx-PVP layers to a working electrode. An EVA layer was spray applied using 4 passes of a 2 wt % EVA solution in xylene to encapsulate the analyte sensing membrane to the dielectric layer.

As illustrated in FIG. 38, the sensor responded well for determining glucose concentration levels of a solution. FIG. 38 illustrates current outputs from the sensors at different glucose concentration levels using a working potential of +700 mV. Each step response is a result of a stepped glucose concentration from 0 to 400 mg/dL in 100 mg/dL increments (e.g., making four separate 100 uL additions of a solution comprising 50% glucose in 50 mL of 1×PBS). The sensors showed good response to changes in glucose concentration. Although output drift was noted, such drift is likely due to over saturation of enzyme layer with glucose and/or drift in the reference electrodes.

Additional sensors were fabricated to determine the efficacy of removing the titanium layer between the platinum and the dielectric. Sensors were prepared as above and included a sensing membrane comprising an electrolyte membrane, which was dispensed onto all sensing electrodes and comprised about 2.5% PVP in acetate buffer and dried 5 minutes at 60° C. Working electrodes were provided with an enzyme membrane, which was dispensed onto the working electrode and comprised about 6% GOx, 3.5% BSA, 2.5% PVP in acetate buffer, 0.0002% glutaraldehyde, and was dried about 2 hours at room temperature. Blank electrode membranes were dispensed onto blank electrode and comprised about 3.5% BSA, 2.5% PVP in acetate buffer and were dried about 2 hours at room temperature. Resistance membrane was provided over the sensor electrodes by dip-coating using a about a 2 minute dwell time in about 6% EVA with 40% VA content and dried about 30 minutes at 60° C.

All membranes were applied at room temperature. Glucose linearity was observed even after varying many of these parameters (e.g. GOx, EVA, drying time, temp).

During initial feasibility tests of some of the microfabricated sensors prepared as described above with the sensing membrane added, an absence of signal response (or a significantly reduced signal) was observed when the sensors were immersed in a peroxide assay. It was generally believed that a thin layer of titanium and/or its native oxide remained on the platinum electrode surface. As a quick diagnostic of the efficacy of the particular etching method, the microfabricated sensors were tested in a hydrogen peroxide assay before and after etching to determine if the sensors output signal improved. Initial testing of some fabricated sensors revealed that the sensors were unresponsive and did not generate a signal regardless of the peroxide concentration. Generally the etched test sensors were compared with an non-etched sensor and control, both the test sensor and control were subject to the following general protocol:
a. Etch the sensing and connection electrodes of sensor;
b. Connect test sensor, non-etched sensor, and a control to a potentiostat;
c. Immerse test sensor, non-etched sensor, and a control in a 50 mL 1×PBS solution with stirring;
d. Predetermined amounts of hydrogen peroxide (˜25 uM) were added to the PBS solutions above and a predetermined potentiostat program was run to measure output current. Thus, etching methods were performed as detailed below.

Solution Based Etching and Non Solution Based Etching Results—

The purpose of the experiment was to determine if etching the instant microfabricated sensor having a dielectric/titanium/platinum construct with a hydrofluoric (HF) solution or by ion beam etching (IBE) would result in improved sensor response to a peroxide assay. Additional testing regarding whether both the sensing and connection electrodes/contacts require etching was investigated. Diluted HF etch solution was prepared by dissolving 5 grams of 20% HF stock solution and 1 gram of 30% H₂O₂ solution in 94 grams of de-ionized water. The final concentration is 1% (weight %) HF and 0.3% (weight %). The HF concentration can range from about 0.5% to about 5%. The H₂O₂ concentration can range from about 0% to about 5%. Alternatively, H₂O₂ can be replaced by nitric acid (HNO₃) at the same concentrations. HF etching was carried out at about room temperature. Slight agitation was used to reduce gas bubbles generated on the electrode surface during etching. Typical etching times was 1.0 minute (from 0.5 to 5 minutes).

Microfabricated sensors having surrounded by titanium adhesion layer sandwiched between a platinum layer and polyimide dielectric layers were exposed to about 1.5 minutes of ion beam etching. The sensors were further processed per two different etching methods (1) and (2) to remove the titanium adhesion layer from the noble metal electrodes. (1) The sensors were exposed to an additional 1.5 minutes of ion beam etching for a total of 3 minutes of ion beam etching. (2) The sensors were immersed and manually agitated in a hydrofluoric acid solution (1% HF, 0.3% H₂O₂) for 1 minute at room temperature. Next, the sensors were connected to potentiostats, held at a working potential of +700 mV, and immersed in a PBS solution. The sensor signal was measured as 25 uM doses of hydrogen peroxide were added to the stirred PBS solution. The peroxide sensitivity results for both etching methods are included in Table 1. To achieve similar results the total ion beam etching time may range from 2.5 minutes to 3.5 minutes. The concentration of the hydrofluoric acid etchant solution may possibly vary from 0.5% to 5% HF and need not include hydrogen peroxide. The temperature of the dilute hydrofluoric solutions may deviate from room temperature.

Table 1 below summarizes the peroxide sensitivity testing for the different etching methods. As shown in Table 1, testing revealed that both etching methods activated MEMS sensors in peroxide assays resulting in linear responses to peroxide concentration. The peroxide sensitivities between the working and blank electrodes were more similar for sensors exposed to IBE. When membranes containing glucose oxidase were applied to the etched sensors, the sensors responded linearly to glucose assays with excellent sensitivity. An example response curve (current-to-glucose concentration) of a microfabricated sensor having been etched to remove the residual titanium layer over the platinum working electrode is shown in FIG. 39. The data of FIG. 39 represents a current-to-glucose concentration response curve, where the glucose concentration was increased from 0 to 400 mg/dL in 100 mg/dL increments (e.g., four separate 200 uL additions of 50% glucose in 100 mL 1×PBS) and the current determined using a potentiostat. The line formed from the current-verses glucose concentration had a linearity (r²) of 0.999 and a slope of 329 pA/mg/dL. Thus, the method disclosed herein provided sensors having improved sensitivity and excellent linearity.

TABLE 1
Peroxide sensitivity test results for etching methods
of microfabricated sensors disclosed herein.

| | | Working | | Blank | |
|---|---|---|---|---|---|
| | | Electrode | | Electrode | |
| | | Peroxide | Working | Peroxide | Blank |
| | Etching | Sensitivity | Electrode | Sensitivity | Electrode |
| Sensor | Process | (pA/uM/L) | R\hat{ }2 | (pA/uM/L) | R² |
| A09705 | 1% HF, | 66.9 | 0.998 | 72.1 | 0.997 |
| | 0.3% | | | | |
| | H₂O₂, | | | | |
| | 1 min | | | | |
| A11804 | 1% HF, | 37.9 | 1.000 | 93.6 | 0.999 |
| | 0.3% | | | | |
| | H₂O₂, | | | | |
| | 1 min | | | | |
| A04505 | 3 minutes | 968.4 | 1.000 | 969.3 | 1.000 |
| | of IBE | | | | |
| A04404 | 3 minutes | 900.8 | 0.999 | 874.2 | 1.000 |
| | of IBE | | | | |

It is understood that if these sensors were not subject to either etching option detailed above, their response to peroxide would have been less, or possibly without response. The results of the experiments on a number of sensors indicated that etching the connections/contacts and sensing electrodes significantly improved sensor response. While, the mechanism is not yet fully understood, and not to be held to any one particular theory, it is believed that the HF or IBE removed a vestigial titanium (oxide) layer on electrodes surface exposing an increased surface area of the electro-active platinum metal. It was generally observed that the signal output of the instant microfabricated sensors to an electochemically active species (e.g., hydrogen peroxide) could be improved by processing (etching) using two different methods, a solution based etching such as hydrogen fluoride, and a non-solution based etching such as ion beam etching. Thus, as observed, to improve the electrochemical response to the instant microfabricated sensors disclosed herein, it is advantageous that before a sensing membrane deposition is performed, the instant microfabricated sensors can be subjected to at least one of the following etching methods:

(1) Immersing in a dilute solution of hydrofluoric acid, for example, for about 0.5 to about 5 minutes; or
(2) Ion beam etching for example, for about 2.5 to about 4.5 minutes.

All references cited herein, including but not limited to published and unpublished applications, patents, and literature references, are incorporated herein by reference in their entirety and are hereby made a part of this specification. To the extent publications and patents or patent applications incorporated by reference contradict the disclosure contained in the specification, the specification is intended to supersede and/or take precedence over any such contradictory material.

All numbers expressing quantities of ingredients, reaction conditions, and so forth used in the specification may be to be understood as being modified in all instances by the term “about.” Accordingly, unless indicated to the contrary, the numerical parameters set forth herein may be approximations that may vary depending upon the desired properties sought to be obtained.

At the very least, each numerical parameter should be construed in light of the number of significant digits and ordinary rounding approaches.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Therefore, it is to be understood that, within the scope of the appended claims, the invention may be practiced other than as specifically described herein.

That which is claimed:

1. A method of fabricating an electrochemical sensor component comprising:
providing a substrate having a transition metal adhesion layer positioned between a dielectric layer and a noble metal electrode, the noble metal electrode having residual amounts of the transition metal adhesion layer on the surface thereof;
contacting the exposed portion of the noble metal electrode with an etchant;
removing at least a portion of the residual transition metal adhesion layer from the surface of the noble metal electrode.

2. The method of claim 1, wherein the transition metal adhesion layer comprises titanium.

3. The method of claim 1, wherein the noble metal comprises gold, platinum, platinum/iridium, or palladium.

4. The method of claim 1, wherein the transition metal adhesion layer comprises titanium and wherein the noble metal comprises gold, platinum, or palladium.

5. The method of claim 1, wherein the etchant is a solution based etchant.

6. The method of claim 5, wherein the etchant comprises hydrogen fluoride.

7. The method of claim 1, wherein the etchant is a non-solution based etchant.

8. The method of claim 1, wherein the non-solution based etchant comprises ions provided by inductively coupled plasma or ion beam.

9. The method of claim 1, wherein the dielectric material is one of an organic polymer, silicon dioxide, silica glass, gallium, or silicon carbide.

10. The method of claim 9, wherein the organic polymer is selected from the group consisting of polyimide, parylene, polyepoxide, and derivatives thereof.

11. The method of claim 1, further comprising depositing an analyte sensing membrane over the surface of the noble metal electrode.

12. A method of improving the electrochemical response of a microfabricated electrochemical sensor component to an electrochemically active species, the method comprising the steps of:
(i) providing a substrate having a transition metal adhesion layer positioned between a dielectric layer and a noble metal electrode, the noble metal electrode having residual amounts of the transition metal adhesion layer on the surface thereof;
(ii) contacting the exposed portion of the noble metal electrode with an etchant; and
(iii) removing at least a portion of the residual transition metal adhesion layer from the surface of the noble metal electrode,
wherein the electrochemical response of the noble metal electrode to an electrochemically active species is greater than without the contacting step.

13. The method of claim 12, wherein the transition metal adhesion layer comprises titanium.

14. The method of claim 12, wherein the noble metal comprises gold, platinum, platinum/iridium, or palladium.

15. The method of claim 12, wherein the transition metal adhesion layer comprises titanium and wherein the noble metal comprises gold, platinum, or palladium.

16. The method of claim 12, wherein the etchant is a solution based etchant.

17. The method of claim 16, wherein the etchant comprises hydrogen fluoride.

18. The method of claim 12, wherein the etchant is a non-solution based etchant.

19. The method of claim 18, wherein the non-solution based etchant comprises ions provided by inductively coupled plasma or ion beam.

20. The method of claim 19, wherein the dielectric material is one of an organic polymer, silicon dioxide, silica glass, gallium, or silicon carbide.

21. The method of claim 19, wherein the organic polymer is selected from the group consisting of polyimide, parylene, polyepoxide, and derivatives thereof.

22. The method of claim 12, further comprising depositing an analyte sensing membrane over the surface of the noble metal electrode.

23. An electrochemical sensor fabricated by the method comprising:
providing a substrate having a transition metal adhesion layer positioned between a dielectric layer and a noble metal electrode, the noble metal electrode having residual amounts of the transition metal adhesion layer on the surface thereof;
contacting at least a portion of a surface of the noble metal electrode with an etchant;
removing at least a portion of the residual transition metal from the surface of the noble metal electrode; and
depositing an analyte sensing membrane over the surface of the noble metal electrode, the analyte sensing membrane comprising:
a hydrophilic polymer layer;
an enzyme layer; and
a flux-limiting layer encapsulating and/or sealing the analyte sensing membrane to the dielectric layer.
